(19) United States
(12) Patent Application Publication
(10) Pub. No.: US 2025/0039869 A1
(43) Pub. Date: Jan. 30, 2025

(54) BEAM INDICATION FOR MULTIPLE COMPONENT CARRIERS FOLLOWING A MAXIMUM PERMISSIBLE EXPOSURE EVENT

(71) Applicant: QUALCOMM INCORPORATED, San Diego, CA (US)

(72) Inventors: Fang YUAN, Beijing (CN); Yan ZHOU, San Diego, CA (US); Wooseok NAM, San Diego, CA (US); Jelena DAMNJANOVIC, Del Mar, CA (US); Junyi LI, Greentown, PA (US); Tao LUO, San Diego, CA (US)

(21) Appl. No.: 18/704,704

(22) PCT Filed: Jan. 6, 2022
(86) PCT No.: PCT/CN2022/070468

§ 371 Date: Apr. 25, 2024

(51) Int. Cl. H04W 72/1268; H04L 1/1812; H04L 5/00; H04W 24/08; H04W 72/231

(52) U.S. Cl. CPC H04W 72/1268; H04L 1/1812; H04L 5/001; H04W 24/08; H04W 72/231

(57) ABSTRACT

Various aspects of the present disclosure generally relate to wireless communication. In some aspects, a user equipment (UE) may transmit, to a base station, a report associated with a maximum permissible exposure event that has occurred for one or more component carriers. The report may indicate one or more candidate beams for each of the one or more component carriers. The UE may receive, from the base station, at least one downlink control information message scheduling an uplink communication on the one or more component carriers. The UE may transmit, to the base station, the uplink communication on the one or more component carriers using at least one transmit beam that corresponds to a candidate beam of the one or more candidate beams for a component carrier of the one or more component carriers. Numerous other aspects are described.

### INTRODUCTION

Aspects of the present disclosure generally relate to wireless communication and to techniques and apparatuses for beam indication for multiple component carriers.

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include transmitting, to a base station, a report associated with a maximum permissible exposure (MPE) event that has occurred for one or more component carriers, the report indicating one or more candidate beams for each of the one or more component carriers. The method may include receiving, from the base station, at least one downlink control information (DCI) message scheduling an uplink communication on the one or more component carriers. The method may include transmitting, to the base station, the uplink communication on the one or more component carriers using at least one transmit beam that corresponds to a candidate beam of the one or more candidate beams for a component carrier of the one or more component carriers.

Some aspects described herein relate to a method of wireless communication performed by a base station. The method may include receiving, from a UE, a report associated with an MPE event that has occurred for one or more component carriers, the report indicating one or more candidate beams for each of the one or more component carriers. The method may include transmitting, to the UE, at least one DCI message scheduling an uplink communication on the one or more component carriers. The method may include receiving, from the UE, the uplink communication on the one or more component carriers using at least one receive beam that corresponds to a candidate beam of the one or more candidate beams for a component carrier of the one or more component carriers.

Some aspects described herein relate to an apparatus for wireless communication at a UE. The apparatus may include a memory and one or more processors coupled to the memory. The memory and the one or more processors may be configured to transmit, to a base station, a report associated with an MPE event that has occurred for one or more component carriers, the report indicating one or more candidate beams for each of the one or more component carriers. The memory and the one or more processors may be configured to receive, from the base station, at least one DCI message scheduling an uplink communication on the one or more component carriers. The memory and the one or more processors may be configured to transmit, to the base station, the uplink communication on the one or more component carriers using at least one transmit beam that corresponds to a candidate beam of the one or more candidate beams for a component carrier of the one or more component carriers.

Some aspects described herein relate to an apparatus for wireless communication at a base station. The apparatus may include a memory and one or more processors coupled to the memory. The memory and the one or more processors may be configured to receive, from a UE, a report associated with an MPE event that has occurred for one or more component carriers, the report indicating one or more candidate beams for each of the one or more component carriers. The memory and the one or more processors may be configured to transmit, to the UE, at least one DCI message scheduling an uplink communication on the one or more component carriers. The memory and the one or more processors may be configured to receive, from the UE, the uplink communication on the one or more component carriers using at least one receive beam that corresponds to a candidate beam of the one or more candidate beams for a component carrier of the one or more component carriers.

Some aspects described herein relate to a non-transitory computer-readable medium that stores a set of instructions for wireless communication by an UE. The set of instructions, when executed by one or more processors of the UE, may cause the UE to transmit, to a base station, a report associated with an MPE event that has occurred for one or more component carriers, the report indicating one or more candidate beams for each of the one or more component carriers. The set of instructions, when executed by one or more processors of the UE, may cause the UE to receive, from the base station, at least one DCI message scheduling an uplink communication on the one or more component carriers. The set of instructions, when executed by one or more processors of the UE, may cause the UE to transmit, to the base station, the uplink communication on the one or more component carriers using at least one transmit beam that corresponds to a candidate beam of the one or more candidate beams for a component carrier of the one or more component carriers.

Some aspects described herein relate to a non-transitory computer-readable medium that stores a set of instructions for wireless communication by a base station. The set of instructions, when executed by one or more processors of the base station, may cause the base station to receive, from a UE, a report associated with an MPE event that has occurred for one or more component carriers, the report indicating one or more candidate beams for each of the one or more component carriers. The set of instructions, when executed by one or more processors of the base station, may cause the base station to transmit, to the UE, at least one DCI message scheduling an uplink communication on the one or more component carriers. The set of instructions, when executed by one or more processors of the base station, may cause the base station to receive, from the UE, the uplink communication on the one or more component carriers using at least one receive beam that corresponds to a candidate beam of the one or more candidate beams for a component carrier of the one or more component carriers.

Some aspects described herein relate to an apparatus for wireless communication. The apparatus may include means for transmitting, to a base station, a report associated with an MPE event that has occurred for one or more component carriers, the report indicating one or more candidate beams for each of the one or more component carriers. The apparatus may include means for receiving, from the base station, at least one DCI message scheduling an uplink communication on the one or more component carriers. The apparatus may include means for transmitting, to the base station, the uplink communication on the one or more component carriers using at least one transmit beam that corresponds to a candidate beam of the one or more candidate beams for a component carrier of the one or more component carriers.

Some aspects described herein relate to an apparatus for wireless communication. The apparatus may include means for receiving, from a UE, a report associated with an MPE event that has occurred for one or more component carriers, the report indicating one or more candidate beams for each of the one or more component carriers. The apparatus may include means for transmitting, to the UE, at least one DCI message scheduling an uplink communication on the one or more component carriers. The apparatus may include means for receiving, from the UE, the uplink communication on the one or more component carriers using at least one receive beam that corresponds to a candidate beam of the one or more candidate beams for a component carrier of the one or more component carriers.

Aspects generally include a method, apparatus, system, computer program product, non-transitory computer-readable medium, user equipment, base station, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of an open radio access network (O-RAN) architecture, in accordance with the present disclosure.

FIG. 4 is a diagram illustrating examples of channel state information reference signal (CSI-RS) beam management procedures, in accordance with the present disclosure.

FIG. 5 is a diagram illustrating an example of communication involving a maximum permissible exposure (MPE) event, in accordance with the present disclosure.

FIG. 6A is a diagram illustrating an example of a slot format, in accordance with the present disclosure.

FIG. 6B is a diagram illustrating examples of carrier aggregation, in accordance with the present disclosure.

FIG. 7 is a diagram illustrating an example of MPE reporting, in accordance with the present disclosure.

FIGS. 8-11 are diagrams illustrating examples associated with beam indication for multiple component carriers following an MPE event, in accordance with the present disclosure.

FIGS. 12-13 are diagrams illustrating example processes associated with beam indication for multiple component carriers following an MPE event, in accordance with the present disclosure.

FIG. 14 is a diagram of an example apparatus for wireless communication, in accordance with the present disclosure.

FIG. 15 is a diagram illustrating an example of a hardware implementation for an apparatus employing a processing system, in accordance with the present disclosure.

FIG. 16 is a diagram illustrating an example implementation of code and circuitry for an apparatus, in accordance with the present disclosure.

FIG. 17 is a diagram of an example apparatus for wireless communication, in accordance with the present disclosure.

FIG. 18 is a diagram illustrating an example of a hardware implementation for an apparatus employing a processing system, in accordance with the present disclosure.

FIG. 19 is a diagram illustrating an example implementation of code and circuitry for an apparatus, in accordance with the present disclosure.

### DETAILED DESCRIPTION

A user equipment (UE) may communicate using carrier aggregation, in which multiple component carriers are used (e.g., as a single channel) to enhance data capacity. Here, the UE may transmit an uplink communication on the multiple component carriers using a different uplink beam on each component carrier. In some examples, the UE may detect a maximum permissible exposure (MPE) event for one or more beams used on one or more of the component carriers. The MPE event may occur when the beam(s) are blocked by a human body, such that a transmission using the beam(s) and directed at the human body would exceed an MPE restriction (e.g., for a maximum radiated power allowed to be directed at a human) set by a governing body.

Due to the MPE event, uplink communications of the UE that use the beam(s) associated with the MPE event may be interrupted. To reduce the amount of interruption, the UE may switch (or reset) uplink beams used for the component carriers associated with the MPE event. In such a scenario, a base station may separately signal one or more new beams that the UE is to switch to for each component carrier. Moreover, the UE may begin to switch to the new beams only after reception of the signaling from the base station, which may impact a timing of when the beams are ready for use by the UE.

Some techniques and apparatuses described herein provide beam indication for multiple component carriers. In some aspects, based at least in part on an MPE event, the UE may transmit, to the base station, a report (e.g., a power headroom report) indicating component carriers that are impacted by the MPE event (e.g., by indicating power backoffs for the component carriers) and indicating candidate beams to switch to on the component carriers. In response, the base station may transmit one or more DCI messages that schedule an uplink communication of the UE on all of the component carriers used for carrier aggregation (e.g., including the one or more component carriers impacted by the MPE event).

In some aspects, the UE may reset an uplink beam (e.g., switch to a new uplink beam) for each of the component carriers associated with the MPE event after receiving the response from the base station. In some aspects, a single downlink control information (DCI) message may provide per-component carrier indications for the component carriers associated with the MPE event indicating whether an uplink beam is to be reset, and, according to one or more examples, the UE may reset uplink beams only for component carriers indicated for beam resetting by the single DCI message. Use of a single DCI message to provide multiple beam resetting indications for multiple component carriers reduces signaling overhead and conserves network resources by reducing the amount of data used to communicate the beam resetting indications relative to using multiple DCI messages. In some aspects, multiple per-component carrier DCI messages may provide respective indications of whether uplink beams are to be reset for the component carriers associated with the MPE event, and, according to one or more examples, the UE may reset uplink beams only for component carriers indicated for beam resetting by the multiple DCI messages. The UE may reset the uplink beam for a component carrier to a candidate beam indicated for that component carrier in the report. Thus, a beam switching latency for a component carrier following the MPE event may be reduced as the UE is able to prepare to use the candidate beam in advance of receiving a beam resetting indication in a DCI message. The UE may transmit the uplink communication to the base station on the one or more component carriers using the reset candidate beams, thereby quickly resolving the MPE event such that minimal interruption to uplink communication of the UE is achieved.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

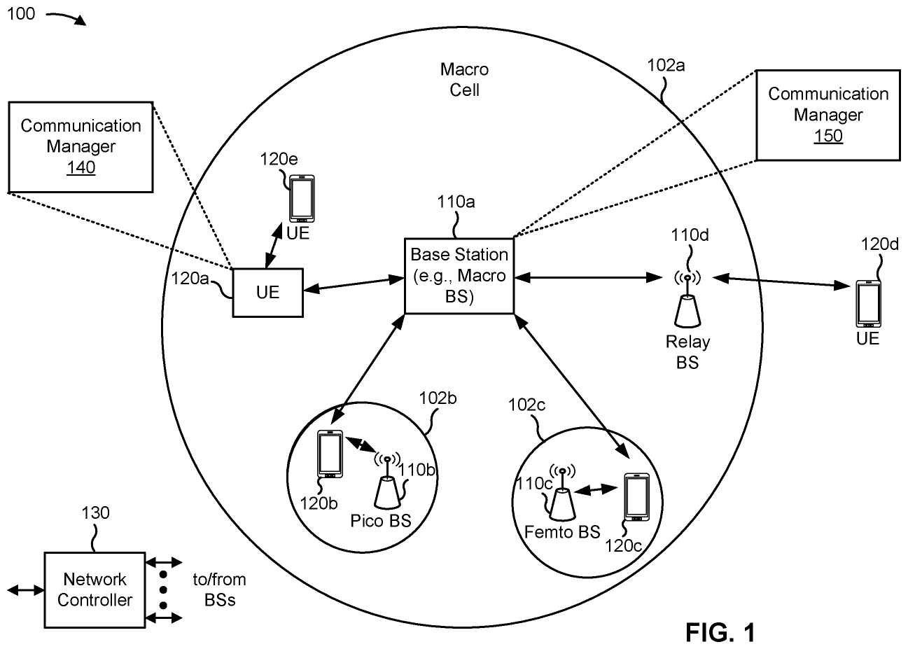

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a UE 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

The electromagnetic spectrum is often subdivided, by frequency/wavelength, into various classes, bands, channels, etc. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may transmit, to a base station, a report associated with an MPE event that has occurred for one or more component carriers, the report indicating one or more candidate beams for each of the one or more component carriers; receive, from the base station, at least one DCI message scheduling an uplink communication on the one or more component carriers; and transmit, to the base station, the uplink communication on the one or more component carriers using at least one transmit beam that corresponds to a candidate beam of the one or more candidate beams for a component carrier of the one or more component carriers. Additionally, or alternatively, the communication manager 140 may perform one or more other operations described herein.

In some aspects, the base station 110 may include a communication manager 150. As described in more detail elsewhere herein, the communication manager 150 may receive, from a UE, a report associated with an MPE event that has occurred for one or more component carriers, the report indicating one or more candidate beams for each of the one or more component carriers; transmit, to the UE, at least one DCI message scheduling an uplink communication on the one or more component carriers; and receive, from the UE, the uplink communication on the one or more component carriers using at least one receive beam that corresponds to a candidate beam of the one or more candidate beams for a component carrier of the one or more component carriers. Additionally, or alternatively, the communication manager 150 may perform one or more other operations described herein.

As indicated above, FIG. 1 is provided as an example. Other examples may differ from what is described with regard to FIG. 1.

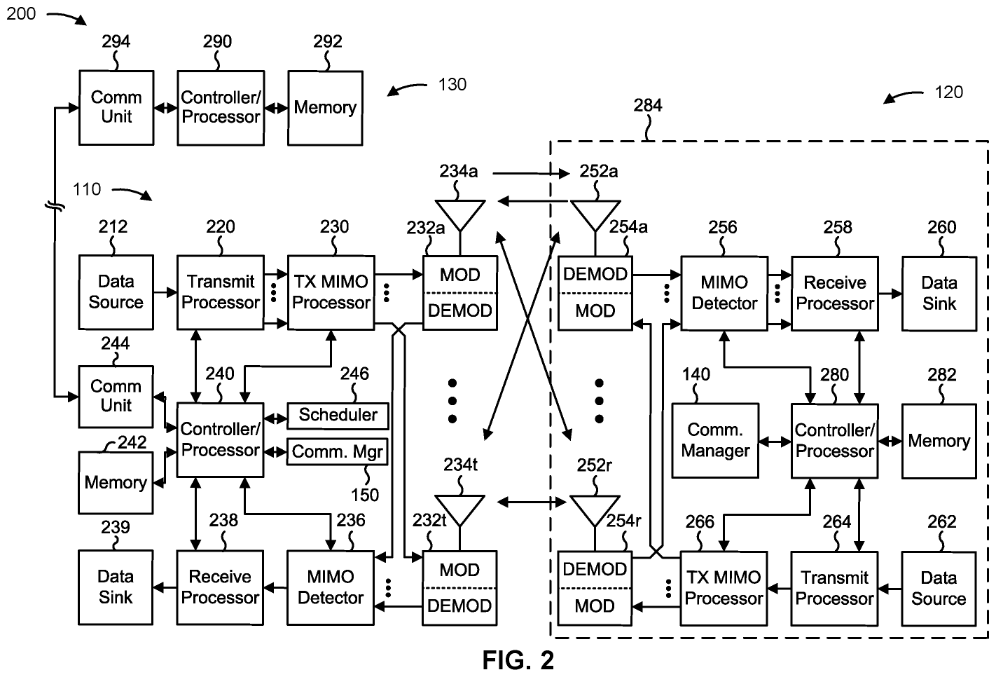

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., Toutput symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein.

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein.

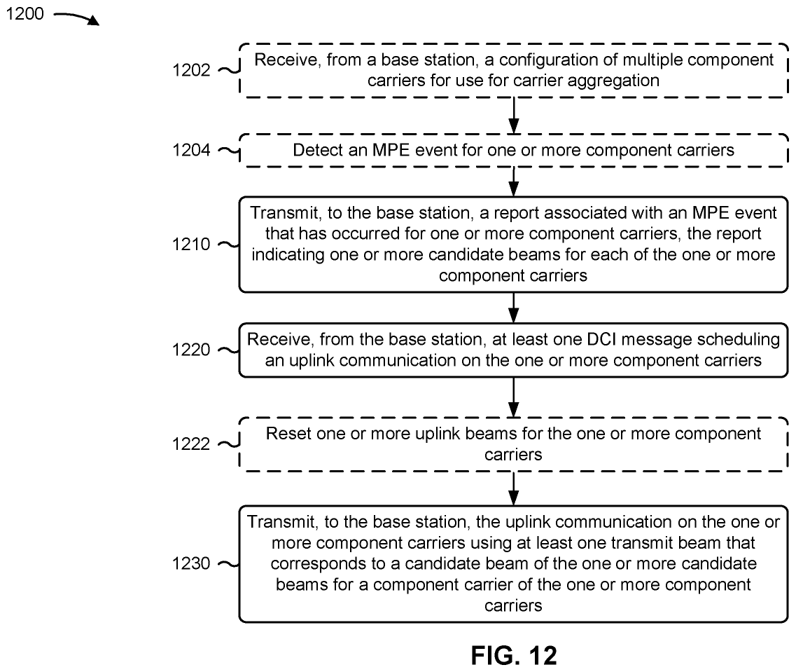

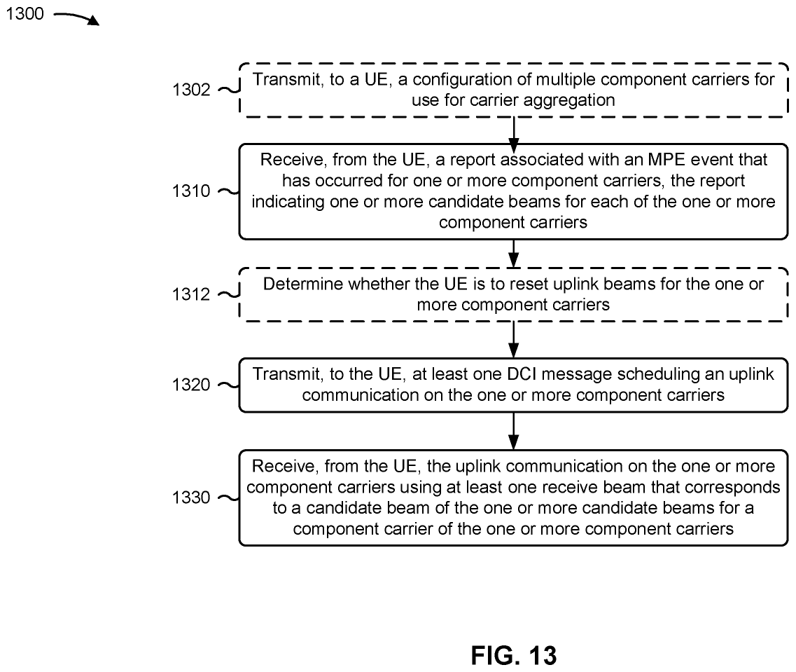

The controller/processor 240 of the base station 110, the controller/processor 280 of the UE 120, and/or any other component(s) of FIG. 2 may perform one or more techniques associated with beam indication for multiple component carriers following an MPE event, as described in more detail elsewhere herein. For example, the controller/processor 240 of the base station 110, the controller/processor 280 of the UE 120, and/or any other component(s) of FIG. 2 may perform or direct operations of, for example, process 1200 of FIG. 12, process 1300 of FIG. 13, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 1200 of FIG. 12, process 1300 of FIG. 13, and/or other processes as described herein. In some examples, executing instructions may include running the instructions, converting the instructions, compiling the instructions, and/or interpreting the instructions, among other examples.

In some aspects, the UE includes means for transmitting, to a base station, a report associated with an MPE event that has occurred for one or more component carriers, the report indicating one or more candidate beams for each of the one or more component carriers; means for receiving, from the base station, at least one DCI message scheduling an uplink communication on the one or more component carriers; and/or means for transmitting, to the base station, the uplink communication on the one or more component carriers using at least one transmit beam that corresponds to a candidate beam of the one or more candidate beams for a component carrier of the one or more component carriers. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the base station includes means for receiving, from a UE, a report associated with an MPE event that has occurred for one or more component carriers, the report indicating one or more candidate beams for each of the one or more component carriers; means for transmitting, to the UE, at least one DCI message scheduling an uplink communication on the one or more component carriers; and/or means for receiving, from the UE, the uplink communication on the one or more component carriers using at least one receive beam that corresponds to a candidate beam of the one or more candidate beams for a component carrier of the one or more component carriers. The means for the base station to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

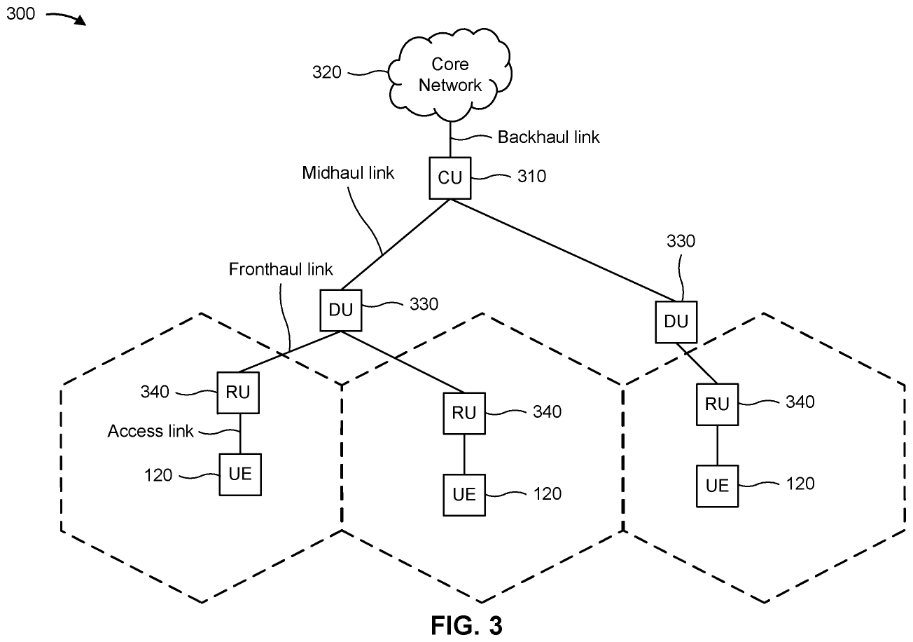

FIG. 3 is a diagram illustrating an example 300 of an open radio access network (O-RAN) architecture, in accordance with the present disclosure. As shown in FIG. 3, the O-RAN architecture may include a control unit (CU) 310 that communicates with a core network 320 via a backhaul link. Furthermore, the CU 310 may communicate with one or more distributed units (DUs) 330 via respective midhaul links. The DUs 330 may each communicate with one or more radio units (RUs) 340 via respective fronthaul links, and the RUs 340 may each communicate with respective UEs 120 via radio frequency (RF) access links. The DUs 330 and the RUs 340 may also be referred to as O-RAN DUS (O-DUs) 330 and O-RAN RUs (O-RUs) 340, respectively.

In some aspects, the DUs 330 and the RUs 340 may be implemented according to a functional split architecture in which functionality of a base station 110 (e.g., an eNB or a gNB) is provided by a DU 330 and one or more RUs 340 that communicate over a fronthaul link. Accordingly, as described herein, a base station 110 may include a DU 330 and one or more RUs 340 that may be co-located or geographically distributed. In some aspects, the DU 330 and the associated RU(s) 340 may communicate via a fronthaul link to exchange real-time control plane information via a lower layer split (LLS) control plane (LLS-C) interface, to exchange non-real-time management information via an LLS management plane (LLS-M) interface, and/or to exchange user plane information via an LLS user plane (LLS-U) interface.

Accordingly, the DU 330 may correspond to a logical unit that includes one or more base station functions to control the operation of one or more RUs 340. For example, in some aspects, the DU 330 may host a radio link control (RLC) layer, a medium access control (MAC) layer, and one or more high physical (PHY) layers (e.g., forward error correction (FEC) encoding and decoding, scrambling, and/or modulation and demodulation) based at least in part on a lower layer functional split. Higher layer control functions, such as a packet data convergence protocol (PDCP), radio resource control (RRC), and/or service data adaptation protocol (SDAP), may be hosted by the CU 310. The RU(s) 340 controlled by a DU 330 may correspond to logical nodes that host RF processing functions and low-PHY layer functions (e.g., fast Fourier transform (FFT), inverse FFT (iFFT), digital beamforming, and/or physical random access channel (PRACH) extraction and filtering) based at least in part on the lower layer functional split. Accordingly, in an O-RAN architecture, the RU(s) 340 handle all over the air (OTA) communication with a UE 120, and real-time and non-real-time aspects of control and user plane communication with the RU(s) 340 are controlled by the corresponding DU 330, which enables the DU(s) 330 and the CU 310 to be implemented in a cloud-based radio access network (RAN) architecture.

As indicated above, FIG. 3 is provided as an example. Other examples may differ from what is described with regard to FIG. 3.

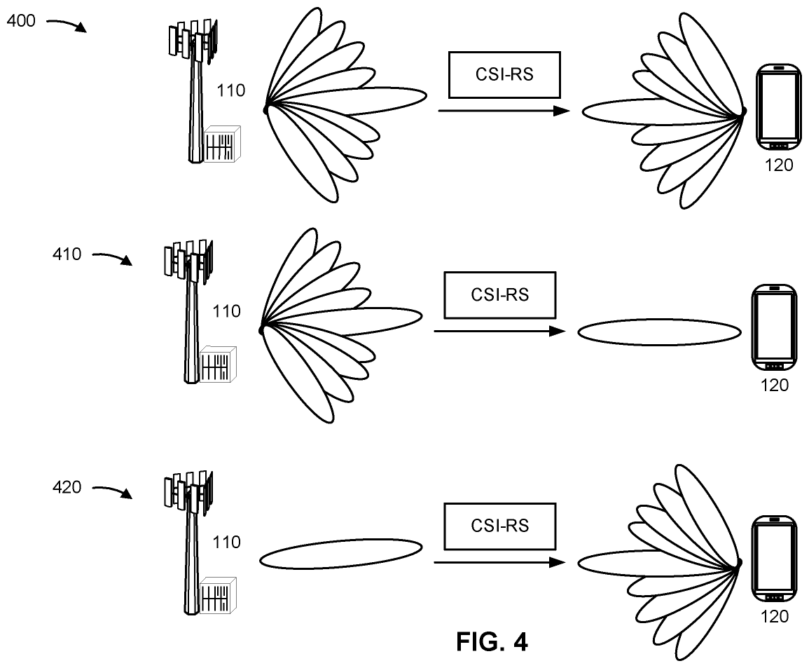

FIG. 4 is a diagram illustrating examples 400, 410, and 420 of channel state information reference signal (CSI-RS) beam management procedures, in accordance with the present disclosure. As shown in FIG. 4, examples 400, 410, and 420 include a UE 120 in communication with a base station 110 in a wireless network (e.g., wireless network 100). However, the devices shown in FIG. 4 are provided as examples, and the wireless network may support communication and beam management between other devices (e.g., between a UE 120 and a base station 110 or TRP, between a mobile termination node and a control node, between an integrated access and backhaul (IAB) child node and an IAB parent node, and/or between a scheduled node and a scheduling node). In some aspects, the UE 120 and the base station 110 may be in a connected state (e.g., an RRC connected state).

As shown in FIG. 4, example 400 may include a base station 110 and a UE 120 communicating to perform beam management using CSI-RSs. Example 400 depicts a first beam management procedure (e.g., P1 CSI-RS beam management). The first beam management procedure may be referred to as a beam selection procedure, an initial beam acquisition procedure, a beam sweeping procedure, a cell search procedure, and/or a beam search procedure. As shown in FIG. 4 and example 400, CSI-RSs may be configured to be transmitted from the base station 110 to the UE 120. The CSI-RSs may be configured to be periodic (e.g., using RRC signaling), semi-persistent (e.g., using MAC control element (MAC-CE) signaling), and/or aperiodic (e.g., using DCI).

The first beam management procedure may include the base station 110 performing beam sweeping over multiple transmit (Tx) beams. The base station 110 may transmit a CSI-RS using each transmit beam for beam management. To enable the UE 120 to perform receive (Rx) beam sweeping, the base station may use a transmit beam to transmit (e.g., with repetitions) each CSI-RS at multiple times within the same RS resource set so that the UE 120 can sweep through receive beams in multiple transmission instances. For example, if the base station 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the base station 110, the UE 120 may perform beam sweeping through the receive beams of the UE 120. As a result, the first beam management procedure may enable the UE 120 to measure a CSI-RS on different transmit beams using different receive beams to support selection of base station 110 transmit beams/UE 120 receive beam(s) beam pair(s). The UE 120 may report the measurements to the base station 110 to enable the base station 110 to select one or more beam pair(s) for communication between the base station 110 and the UE 120. While example 400 has been described in connection with CSI-RSs, the first beam management process may also use synchronization signal block (SSBs) for beam management in a similar manner as described above.

As shown in FIG. 4, example 410 may include a base station 110 and a UE 120 communicating to perform beam management using CSI-RSs. Example 310 depicts a second beam management procedure (e.g., P2 CSI-RS beam management). The second beam management procedure may be referred to as a beam refinement procedure, a base station beam refinement procedure, a TRP beam refinement procedure, and/or a transmit beam refinement procedure. As shown in FIG. 3 and example 410, CSI-RSs may be configured to be transmitted from the base station 110 to the UE 120. The CSI-RSs may be configured to be aperiodic (e.g., using DCI). The second beam management procedure may include the base station 110 performing beam sweeping over one or more transmit beams. The one or more transmit beams may be a subset of all transmit beams associated with the base station 110 (e.g., determined based at least in part on measurements reported by the UE 120 in connection with the first beam management procedure). The base station 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure may enable the base station 110 to select a best transmit beam based at least in part on measurements of the CSI-RSs (e.g., measured by the UE 120 using the single receive beam) reported by the UE 120.

As shown in FIG. 4, example 420 depicts a third beam management procedure (e.g., P3 CSI-RS beam management). The third beam management procedure may be referred to as a beam refinement procedure, a UE beam refinement procedure, and/or a receive beam refinement procedure. As shown in FIG. 4 and example 420, one or more CSI-RSs may be configured to be transmitted from the base station 110 to the UE 120. The CSI-RSs may be configured to be aperiodic (e.g., using DCI). The third beam management process may include the base station 110 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the base station may use a transmit beam to transmit (e.g., with repetitions) CSI-RS at multiple times within the same RS resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the base station 110 and/or the UE 120 to select a best receive beam based at least in part on reported measurements received from the UE 120 (e.g., of the CSI-RS of the transmit beam using the one or more receive beams).

As indicated above, FIG. 4 is provided as an example of beam management procedures. Other examples of beam management procedures may differ from what is described with respect to FIG. 4. For example, the UE 120 and the base station 110 may perform the third beam management procedure before performing the second beam management procedure, and/or the UE 120 and the base station 110 may perform a similar beam management procedure to select a UE transmit beam.

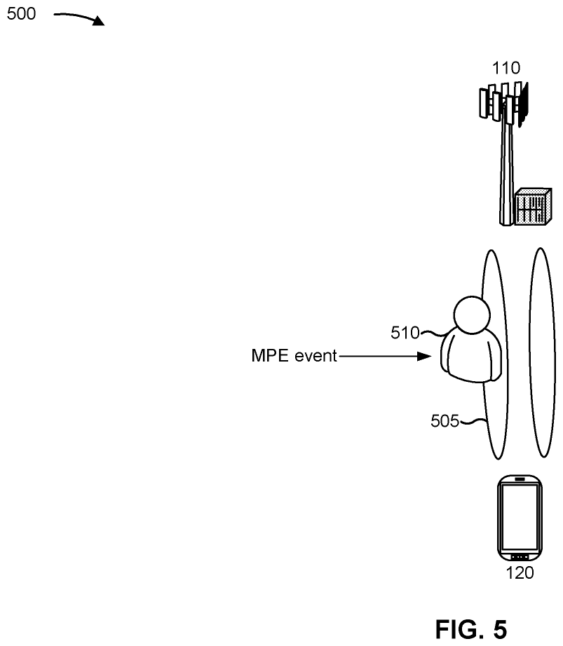

FIG. 5 is a diagram illustrating an example 500 of communication involving an MPE event, in accordance with the present disclosure. As shown in FIG. 4, a UE 120 and a base station 110 may communicate via one or more beams. A beam may be a millimeter wave (mmWave) beam that carries a communication in the mmWave frequency band. When transmitting in the mm Wave frequency band, a transmitter may use a higher antenna gain as compared to transmitting in the sub-6 GHz frequency band. As a result, the effective isotropic radiated power (EIRP), which represents the radiated power in a particular direction (e.g., the direction of the beam), may be higher for mm Wave communications as compared to sub-6 GHz communications. To improve safety, some governing bodies have placed restrictions on the peak EIRP that can be directed toward the human body. These restrictions are sometimes referred to as MPE limitations, MPE constraints, and/or the like.

As shown in FIG. 5, an uplink beam 505 used by the UE 120 to transmit an uplink communication may become subject to an MPE condition. For example, the uplink beam 505 may become subject to the MPE condition upon the occurrence of an MPE event. The MPE event may be a human body 510, or the like, blocking the uplink beam 505 (e.g., the uplink beam 505 may be directed toward the human body 510). That is, the human body 510 may block or obstruct communications to and/or from an antenna subarray of the UE 120, or may otherwise be positioned near the antenna subarray. When the uplink beam 505 is subject to the MPE condition, the uplink beam 505 may not be permitted for use or may only be permitted for use at reduced power.

As indicated above, FIG. 5 is provided as an example. Other examples may differ from what is described with respect to FIG. 5.

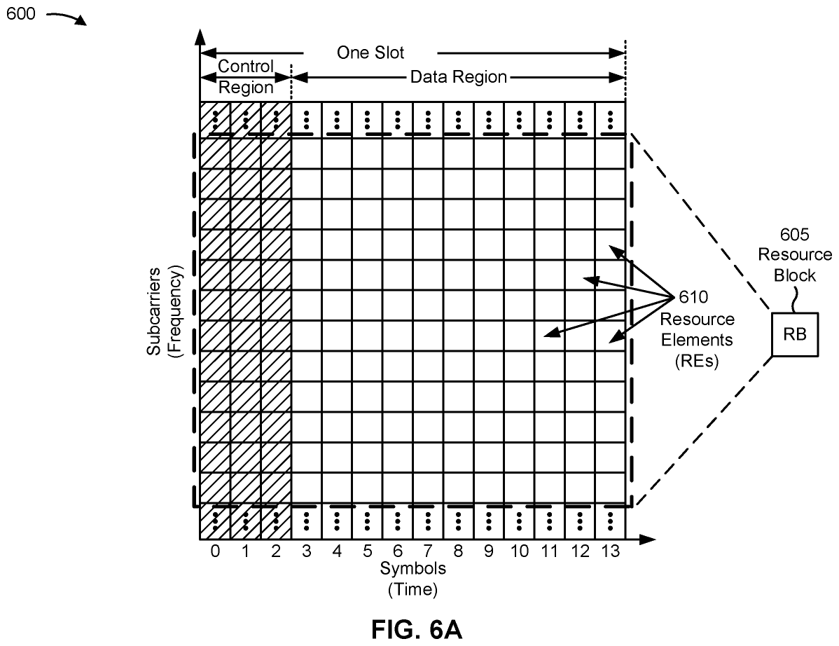

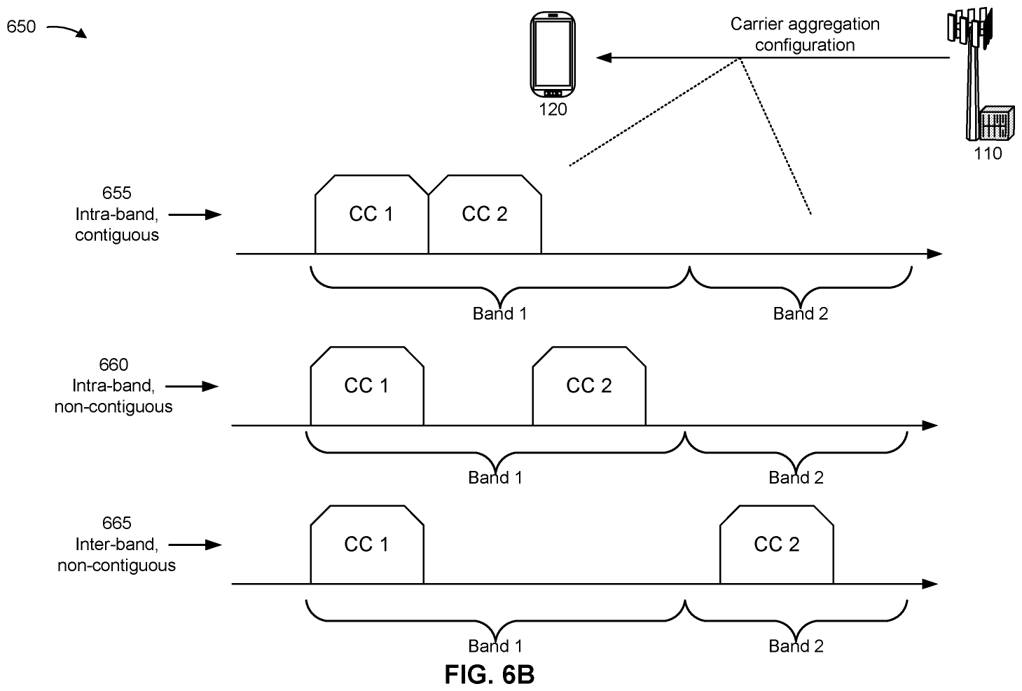

FIG. 6A is a diagram illustrating an example 600 of a slot format, in accordance with the present disclosure. As shown in FIG. 6A, time-frequency resources in a radio access network may be partitioned into resource blocks, shown by a single resource block (RB) 605. An RB 605 is sometimes referred to as a physical resource block (PRB). An RB 605 includes a set of subcarriers (e.g., 12 subcarriers) and a set of symbols (e.g., 14 symbols) that are schedulable by a base station 110 as a unit. In some aspects, an RB 605 may include a set of subcarriers in a single slot. As shown, a single time-frequency resource included in an RB 605 may be referred to as a resource element (RE) 610. An RE 610 may include a single subcarrier (e.g., in frequency) and a single symbol (e.g., in time). A symbol may be referred to as an orthogonal frequency division multiplexing (OFDM) symbol. An RE 610 may be used to transmit one modulated symbol, which may be a real value or a complex value.

In some telecommunication systems (e.g., NR), RBs 605 may span 12 subcarriers with a subcarrier spacing of, for example, 15 kilohertz (kHz), 30 kHz, 60 kHz, or 120 kHz, among other examples, over a 0.1 millisecond (ms) duration. A radio frame may include 40 slots and may have a length of 10 ms. Consequently, each slot may have a length of 0.25 ms. However, a slot length may vary depending on a numerology used to communicate (e.g., a subcarrier spacing and/or a cyclic prefix format). A slot may be configured with a link direction (e.g., downlink or uplink) for transmission. In some aspects, the link direction for a slot may be dynamically configured.

As indicated above, FIG. 6A is provided as an example. Other examples may differ from what is described with respect to FIG. 6A.

FIG. 6B is a diagram illustrating examples 650 of carrier aggregation, in accordance with the present disclosure.

Carrier aggregation is a technology that enables two or more component carriers (CCs, sometimes referred to as carriers) to be combined (e.g., into a single channel) for a single UE 120 to enhance data capacity. As shown, carriers can be combined in the same or different frequency bands. Additionally, or alternatively, contiguous or non-contiguous carriers can be combined. As shown, a base station 110 may configure carrier aggregation for the UE 120, such as in an RRC message, DCI, and/or another signaling message.

As shown by reference number 655, in some aspects, carrier aggregation may be configured in an intra-band contiguous mode where the aggregated carriers are contiguous to one another and are in the same band. As shown by reference number 660, in some aspects, carrier aggregation may be configured in an intra-band non-contiguous mode where the aggregated carriers are non-contiguous to one another and are in the same band. As shown by reference number 665, in some aspects, carrier aggregation may be configured in an inter-band non-contiguous mode where the aggregated carriers are non-contiguous to one another and are in different bands.

In carrier aggregation, the UE 120 may be configured with a primary carrier or primary cell (PCell) and one or more secondary carriers or secondary cells (SCells). The terms “component carrier” or “carrier” may be used interchangeably herein with the term “cell.” In some aspects, the primary carrier may carry control information (e.g., downlink control information and/or scheduling information) for scheduling data communications on one or more secondary carriers, which may be referred to as cross-carrier scheduling. In some aspects, a carrier (e.g., a primary carrier or a secondary carrier) may carry control information for scheduling data communications on the carrier, which may be referred to as self-carrier scheduling or carrier self-scheduling.

As described herein, uplink beams used by the UE 120 for one or more component carriers configured for the UE 120 may be associated with an MPE event (e.g., due to blocking of the beams by a human body). In other words, the one or more uplink beams may be subject to an MPE condition.

As indicated above, FIG. 6B is provided as an example. Other examples may differ from what is described with regard to FIG. 6B.

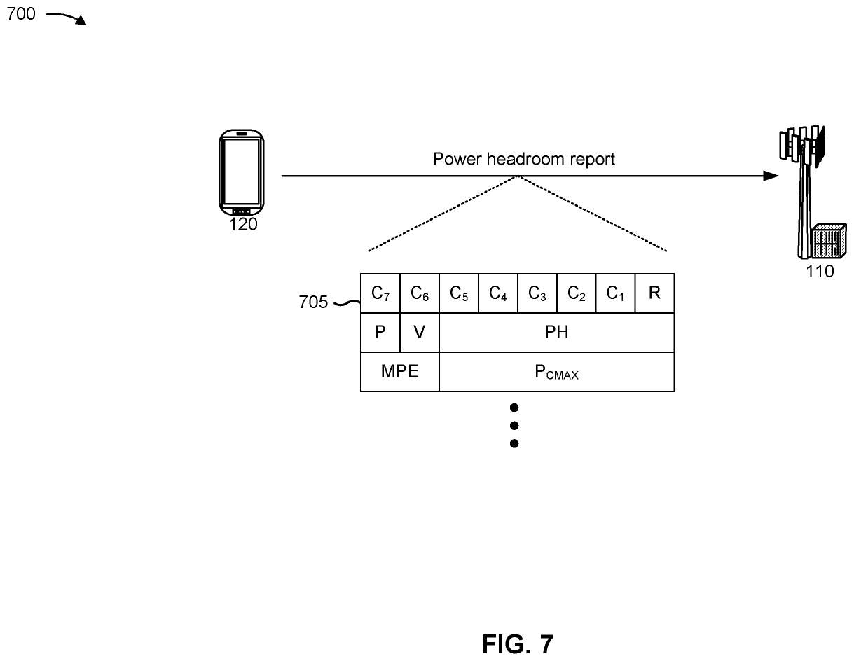

FIG. 7 is a diagram illustrating an example 700 of MPE reporting, in accordance with the present disclosure. As shown in FIG. 7, a UE 120 may transmit, and a base station 110 may receive, a power headroom report 705. The UE 120 may transmit the power headroom report 705 in a MAC-CE. The power headroom report 705 may relate to a single antenna panel of the UE 120. Moreover, the power headroom report 705 may relate to multiple cells (e.g., if the UE 120 is configured for carrier aggregation) or to a single cell.

The power headroom report 705, relating to multiple cells, may indicate (e.g., in a bitmap) the serving cell indices (shown as C₁ through C₇) for which power headroom is reported in the power headroom report 705. For each of the indicated serving cells, the power headroom report 705 may include a power headroom (PH) field, a P_{CMAX} (e.g., P_{CMAX,f,c}) field, a V field, a P field, and an MPE field. The PH field may be used to indicate a power headroom level. The P_{CMAX} field may be used to indicate a maximum power used for calculation of the reported power headroom level. The V field may be used to indicate whether the reported power headroom is based on a real transmission or a reference format. If a virtual power headroom based on a reference format is reported, then the maximum power in the P_{CMAX} field may not be reported. If MPE reporting is configured for the UE 120, the P field may indicate a first value (e.g., 0) if a power backoff (e.g., a power management minimum power reduction (P-MPR) value) is less than a threshold value (referred to as “P-MPR_00”) and may indicate a second value (e.g., 1) otherwise. If MPE reporting is not configured for the UE 120, the P field may indicate the second value (e.g., 1) if the P_{CMAX,f,c} field would have indicated a different value if no power backoff due to power management had been applied (e.g., here, the P field indicates whether power backoff is applied due to power management). If MPE reporting is configured for the UE 120 and the P field indicates the second value (e.g., 1), then the MPE field may be used to indicate a power backoff applied to meet MPE requirements (e.g., the MPE field may indicate an index value of corresponding measured values of P-MPR levels in decibels (dB)). If MPE reporting is not configured for the UE 120 or if the P field indicates the first value (e.g., 0), then reserved bits are present instead of the MPE field. The power headroom report 705, relating to a single cell, may include a PH field, a P_{CMAX} (e.g., P_{CMAX,ACI}) field, a P field, and an MPE field, in a similar manner as described herein.

As described above, the power headroom report 705 may include event-triggered (e.g., when the UE 120 experiences an MPE event) P-MPR-based reporting (e.g., power backoff reporting), which may be included in the power headroom report 705 if a threshold is reached. Thus, one or more P-MPR values may be reported in the power headroom report 705. Moreover, for each reported P-MPR value, the power headroom report 705 may indicate one or more SSB resource indicators (SSBRIs) and/or CSI-RS resource indicators (CRIs) (e.g., to indicate one or more beams). The UE 120 may select the SSBRIs and/or the CRIs from a candidate SSB/CSI-RS resource pool. The power headroom report 705 indicating P-MPR values and beams may be referred to herein as an “enhanced MPE report.”

As indicated above, FIG. 7 is provided as an example. Other examples may differ from what is described with respect to FIG. 7.

In the case of an MPE event at the UE 120, uplink communications of the UE 120 may be interrupted due to power reduction. To reduce the amount of interruption, the UE 120 may switch (or reset) an uplink beam used by the UE 120 (e.g., to an uplink beam that is not limited by MPE). However, if communication of the UE 120 is performed on multiple component carriers for carrier aggregation, the base station 110 may need to separately signal the new beams that the UE 120 is to switch to for each component carrier. Moreover, the UE 120 may begin switching to the new beams after reception of the signaling from the base station 110, which may impact a timing of when the beams are ready for use by the UE 120.

Some techniques and apparatuses described herein provide beam indication for multiple component carriers. For example, the base station 110 may indicate, for each component carrier, whether the UE 120 is to reset an uplink beam used for the component carrier. In some aspects, the UE 120 may transmit a report associated with an MPE event for one or more component carriers (e.g., the UE 120 may transmit the power headroom report 705, where P-MPR values are reported in MPE fields for the component carrier(s)). Moreover, the report may indicate one or more candidate beams (e.g., using SSBRIs and/or CRIs) to switch to for each of the one or more component carriers (e.g., the report may respectively indicate one or more candidate beams for each of the component carrier(s)).

In response, the base station 110 may transmit one or more DCI messages that schedule an uplink communication of the UE 120 on all of the component carriers configured for the UE 120 (e.g., including the one or more component carriers impacted by the MPE event). In some aspects, the UE 120 may reset an uplink beam (e.g., switch to a new uplink beam) for each of the component carriers associated with the MPE event after receiving the response from the base station 110. That is, the UE 120 may reset an uplink beam for a component carrier only if the MPE event and a candidate uplink beam were reported for the component carrier. In some aspects, a single DCI message may provide per-component carrier indications for the component carriers associated with the MPE event indicating whether an uplink beam is to be reset, and, according to one or more examples, the UE 120 may reset uplink beams only for component carriers indicated by the single DCI message for beam resetting. Use of a single DCI message to provide beam resetting indications reduces signaling overhead and conserves network resources by reducing the amount of data used to communicate the beam resetting indications relative to using multiple DCI messages. In some aspects, multiple per-component carrier DCI messages may provide respective indications of whether uplink beams are to be reset for the component carriers associated with the MPE event, and, according to one or more examples, the UE 120 may reset uplink beams only for component carriers indicated for beam resetting by the multiple DCI messages. The UE 120 may reset the uplink beam (e.g., the transmit beam) for a component carrier to a candidate beam indicated for that component carrier in the report (e.g., the UE 120 may reset the uplink beam used for uplink transmissions in a cell reported with the MPE event to a best candidate beam reported in the report for the cell). In this way, a beam switching latency for a component carrier following the MPE event may be reduced as the UE 120 is able to prepare to use the candidate beam in advance of receiving a beam resetting indication in a DCI message. The UE 120 may transmit the uplink communication to the base station 110 on the one or more component carriers using the reset candidate beams, thereby quickly resolving the MPE event such that minimal interruption to uplink communication of the UE 120 is achieved.

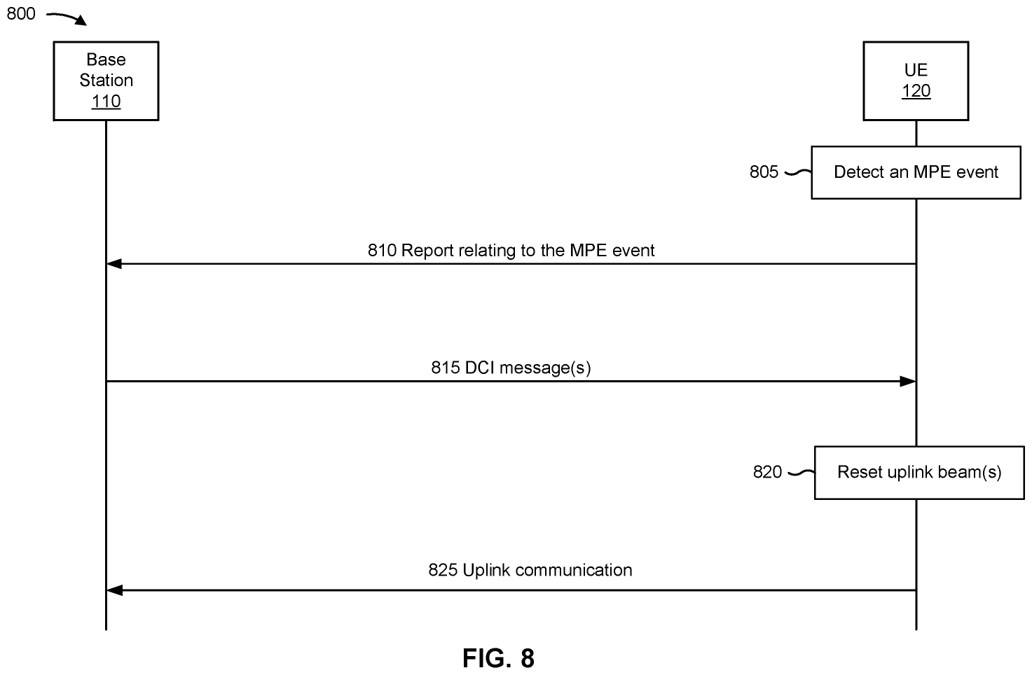

FIG. 8 is a diagram illustrating an example 800 associated with beam indication for multiple component carriers following an MPE event, in accordance with the present disclosure. As shown in FIG. 8, a base station 110 and a UE 120 may communicate with one another. For example, the base station 110 and the UE 120 may communicate using carrier aggregation, as described herein. That is, the UE 120 may be configured with multiple component carriers for communication using carrier aggregation.

As shown by reference number 805, the UE 120 may detect an MPE event for one or more component carriers. For example, the UE 120 may detect that uplink beams used for the one or more component carriers are blocked by a human body. The one or more component carriers associated with the MPE event may be referred to herein as “MPE component carrier(s).”

As shown by reference number 810, the UE 120 may transmit, and the base station 110 may receive, a report associated with the MPE event for the MPE component carriers. For example, the report may be a power headroom report, as described herein. Here, the report may indicate the MPE event for the MPE component carriers in respective MPE fields, as described herein. For example, the report may indicate power backoffs (e.g., P-MPR values) for the MPE component carriers in the respective MPE fields, to thereby indicate the MPE event for the MPE component carriers. In some aspects, the report may further indicate one or more candidate beams for each of the MPE component carriers (i.e., the report may be an enhanced MPE report, as described herein). That is, the report may indicate an association between a reported P-MPR value and one or more candidate beams for an MPE component carrier. As described herein, the report may indicate candidate beams using SSBRIs and/or CRIs. In some aspects, a candidate beam may be associated with a P-MPR value that is less than a threshold.

As shown by reference number 815, the base station 110 may transmit, and the UE 120 may receive, one or more DCI messages. The DCI message(s) may schedule an uplink communication (e.g., a physical uplink control channel (PUCCH) transmission and/or a physical uplink shared channel (PUSCH) transmission) on the multiple component carriers configured for carrier aggregation, including the MPE component carriers. That is, the DCI message(s) may schedule the uplink communication (e.g., at least in part) on the MPE component carriers. In addition, the DCI message(s) may provide an indication of whether the UE 120 is to reset one or more uplink beams for the MPE component carriers according to the reported candidate beams. Thus, the base station 110 may determine whether the UE 120 is to reset one or more uplink beams for the MPE component carriers according to the reported candidate beams. The DCI message(s) may implicitly or explicitly provide the indication, as described herein.

In some aspects, the DCI message(s) (e.g., a single DCI message) is in a format for scheduling a PUSCH transmission, indicates a same hybrid automatic repeat request (HARQ) process identifier as a HARQ process identifier for a transmission of a first PUSCH for the report (i.e., the enhanced MPE report), and/or indicates a toggled new data indicator (NDI) (e.g., to indicate new data assignment). Here, reception of the DCI message(s) by the UE 120 may implicitly indicate (e.g., if the NDI is toggled for the HARQ process) that the UE 120 is to reset (or switch) the uplink beams for all the MPE component carriers (or cells), after receiving the DCI message(s), to the respective candidate beams indicated for the MPE component carriers in the report.

In some aspects, the DCI message(s) may be a single (e.g., dedicated) DCI message received by the UE 120 on one component carrier (e.g., on one cell) configured for carrier aggregation. In some aspects, multiple fields of the DCI message may provide (e.g., explicitly) indications of uplink beam resetting for different component carriers. For example, the DCI message may include respective fields for component carriers (i.e., per-component carrier fields) indicating whether beam resetting is to be performed (e.g., the DCI message may provide explicit per-component carrier indications as to whether an uplink beam reset is to be applied for each component carrier). As an example, the DCI message may include a bitmap where each bit of the bitmap indicates whether uplink beam resetting is to be performed for a particular component carrier (or cell). In some aspects, the respective fields of the DCI message may be mapped one-to-one (e.g., in order) with the MPE component carriers reported by the UE 120. In some aspects, the respective fields of the DCI message may be mapped one-to-one (e.g., in order) with all of the component carriers configured for carrier aggregation.

In some aspects, the DCI message(s) may be multiple DCI messages received by the UE 120 on respective component carriers (e.g., on different cells). The multiple DCI messages may respectively indicate (e.g., explicitly) whether beam resetting is to be performed for the MPE component carriers (e.g., whether an uplink beam reset is to be applied for each component carrier).

As shown by reference number 820, the UE 120 may reset the uplink beam for one or more of the MPE component carriers. For example, in connection with implicitly indicated beam resetting, the UE 120 may reset the uplink beams (e.g., transmit beams) for all the MPE component carriers (or cells), after receiving the DCI message(s). As another example, in connection with explicitly indicated beam resetting using the single DCI message, the UE 120 may reset the uplink beams only for component carriers of the MPE component carriers indicated for beam resetting in the single DCI message. As a further example, in connection with explicitly indicated beam resetting using the multiple DCI messages, the UE 120 may reset the uplink beams only for component carriers of the MPE component carriers indicated for beam resetting in the multiple DCI messages.

The UE 120 may reset an uplink beam for a component carrier to the candidate beam indicated for the component carrier in the report. If multiple candidate beams are indicated for the component carrier in the report, then the UE 120 may reset the uplink beam to a best candidate beam (e.g., a candidate beam associated with a highest RSRP, RSSI, and/or RSRQ, among other examples).

As shown by reference number 825, the UE 120 may transmit, and the base station 110 may receive, the uplink communication (e.g., a PUCCH communication and/or a PUSCH communication) scheduled by the DCI message(s) on the component carriers configured for carrier aggregation, including the MPE component carriers. That is, the UE 120 may transmit the uplink communication on the MPE component carriers. The UE 120 may transmit the uplink communication using at least one uplink beam (e.g., transmit beam) that corresponds to a candidate beam indicated in the report for a component carrier (e.g., the UE 120 may transmit the uplink communication using the same spatial domain filter as a spatial domain filter corresponding to the candidate beam). Similarly, the base station 110 may receive the uplink communication using at least one uplink beam (e.g., receive beam) that corresponds to the candidate beam indicated in the report for the component carrier. In connection with implicitly indicated beam resetting, the UE 120 may transmit the uplink communication using respective candidate beams (e.g., using the same spatial domain filters as respective spatial domain filters corresponding to the candidate beams) for all of the MPE component carriers in response to the DCI message(s) being received by the UE 120 (e.g., because the UE 120 has reset the uplink beams for all of the MPE component carriers, as described in connection with reference number 820). As another example, in connection with explicitly indicated beam resetting, the UE 120 may transmit the uplink communication using respective candidate beams (e.g., using the same spatial domain filters as respective spatial domain filters corresponding to the candidate beams) for only component carriers of the MPE component carriers indicated for beam resetting in the single DCI message or the multiple DCI messages (e.g., because the UE 120 has reset the uplink beams only for those component carriers, as described in connection with reference number 820).

In some aspects, such as in connection with implicitly indicated beam resetting (e.g., where the DCI message(s) is in a format for scheduling a PUSCH transmission, indicates a same HARQ process identifier as a HARQ process identifier for a transmission of a first PUSCH for the report, and/or indicates a toggled NDI), the UE 120 may transmit the uplink communication after a threshold quantity of symbols (e.g., 28 symbols) from a last symbol of reception of a physical downlink control channel (PDCCH) carrying the DCI message(s). In some aspects, a subcarrier spacing (SCS) for the threshold quantity of symbols is a lesser of (e.g., a lower value of) a first SCS configuration for an active downlink bandwidth part for reception of the PDCCH carrying the DCI message(s) or a second SCS configuration for at least one secondary cell associated with the MPE component carriers.

As indicated above, FIG. 8 is provided as an example. Other examples may differ from what is described with respect to FIG. 8.

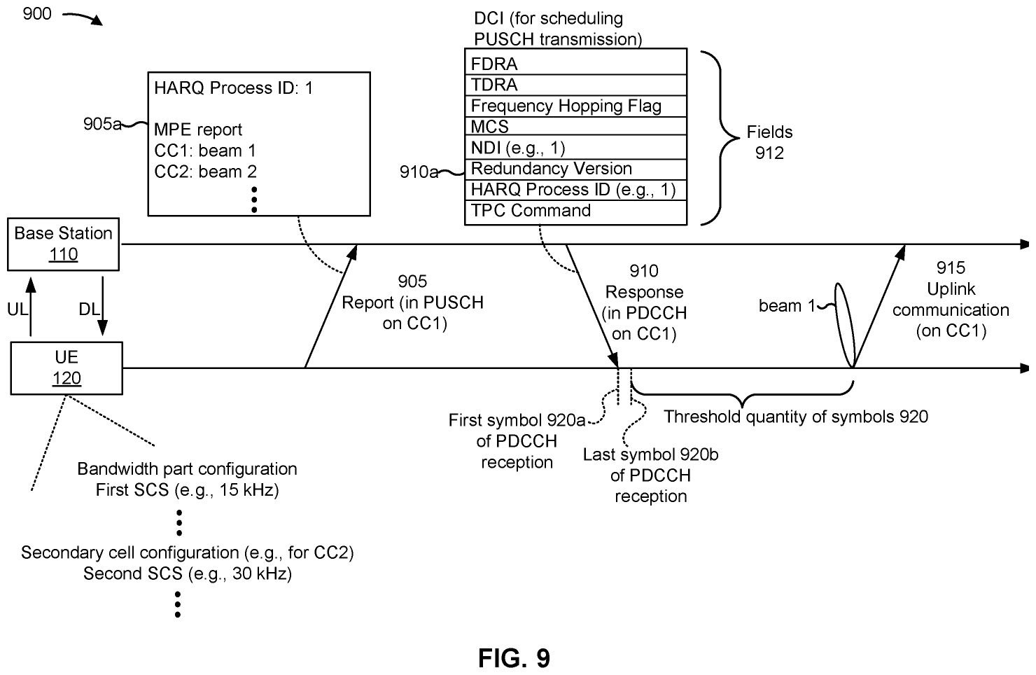

FIG. 9 is a diagram illustrating an example 900 associated with beam indication for multiple component carriers following an MPE event, in accordance with the present disclosure. As shown in FIG. 9, a base station 110 and a UE 120 may communicate with one another. For example, the base station 110 and the UE 120 may communicate using carrier aggregation, as described herein. That is, the UE 120 may be configured with multiple component carriers for communication using carrier aggregation. As shown, the UE 120 may have one or more bandwidth part configurations. A bandwidth part configuration may indicate an SCS for the bandwidth part (shown as a “first SCS”). The UE 120 may have one or more SCell configurations. An SCell configuration may indicate an SCS for the SCell (shown as “second SCS”).

As shown by reference number 905, the UE 120 may transmit, and the base station 110 may receive, a report 905a (e.g., an enhanced MPE report), in a similar manner as described in connection with FIG. 8. The UE 120 may transmit the report 905a in a PUSCH on a first component carrier CC1, as shown. The report may indicate respective candidate beams (e.g., one or more candidate beams) for one or more MPE component carriers. For example, as shown, the report may indicate a first beam beam 1 for the first component carrier CC1 and a second beam beam 2 for a second component carrier CC2. The PUSCH communication may also indicate a HARQ process identifier.

As shown by reference number 910, the base station 110 may transmit, and the UE 120 may receive, a response message. As described herein, the response message may be a DCI message 910a scheduling an uplink communication. The DCI message 910a may include a plurality of fields 912, such as a frequency domain resource allocation (FDRA) field, a time domain resource allocation (TDRA) field, a frequency hopping flag field, an MCS field, an NDI field, a redundancy version field, a HARQ process identifier field, and/or a transmit power control (TPC) command field, among other examples. For example, the DCI message 910a may be in a format for scheduling a PUSCH transmission, indicate a same HARQ process identifier as a HARQ process identifier for a transmission of a first PUSCH for the report 905a, and/or indicate a toggled NDI (e.g., an NDI field set to a value of 1, as shown). The UE 120 may reset an uplink beam for all MPE component carriers (e.g., the first component carrier CC1 and the second component carrier CC2) to the respective candidate beams indicated in the report 905a after receiving the response message from the base station 110. For example, the UE 120 may reset the uplink beam for the first component carrier CC1 to the first beam beam 1 and reset the uplink beam for the second component carrier CC2 to the second beam beam 2.

As shown by reference number 915, the UE 120 may transmit, and the base station 110 may receive, the uplink communication (i.e., an uplink transmission) on a component carrier using a candidate beam (e.g., using a same spatial domain filter as a spatial domain filter corresponding to the best candidate beam for the component carrier). For example, the UE 120 may transmit the uplink communication on the first component carrier CC1 using the first beam beam 1, as shown. Additionally, the UE 120 may transmit the uplink communication on the second component carrier CC2 using the second beam beam 2, which is not shown in FIG. 9. As shown, the UE 120 may transmit the uplink communication after a threshold quantity of symbols 920 (e.g., 28 symbols) from a last symbol 920b of reception (e.g., beginning from a first symbol 920a) of a PDCCH carrying the DCI message. As described herein, an SCS for the threshold quantity of symbols may be a lesser of the first SCS configured for the downlink bandwidth part for reception of the PDCCH carrying the DCI message 910a or the second SCS configured for the SCell associated with the MPE component carriers (e.g., CC2).

As indicated above, FIG. 9 is provided as an example. Other examples may differ from what is described with respect to FIG. 9.

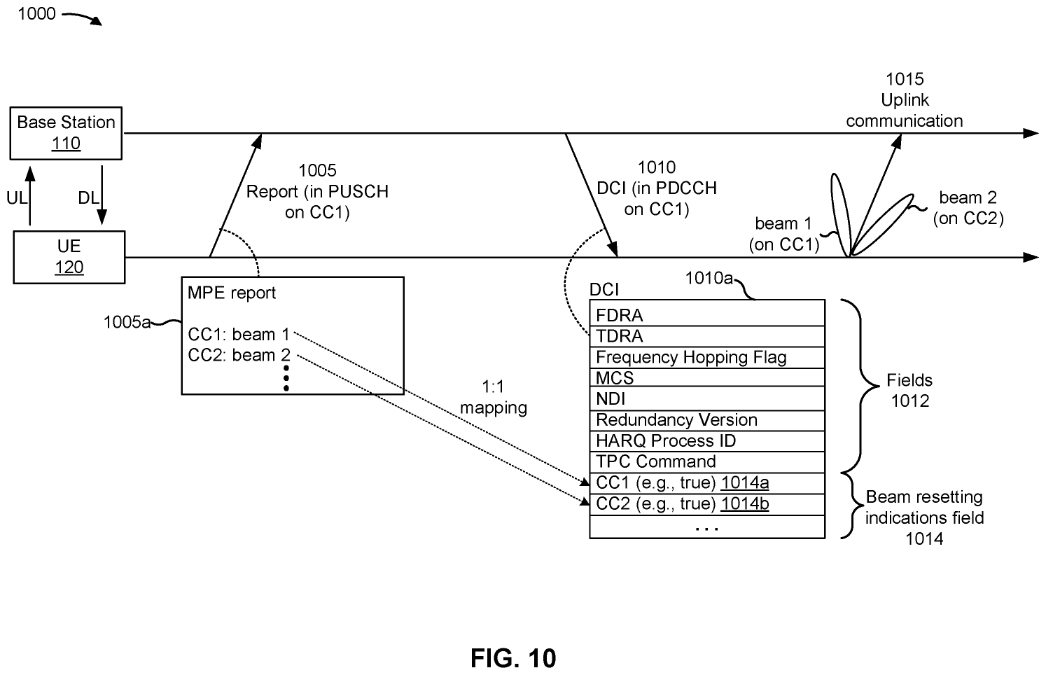

FIG. 10 is a diagram illustrating an example 1000 associated with beam indication for multiple component carriers following an MPE event, in accordance with the present disclosure. As shown in FIG. 10, a base station 110 and a UE 120 may communicate with one another. For example, the base station 110 and the UE 120 may communicate using carrier aggregation, as described herein. That is, the UE 120 may be configured with multiple component carriers for communication using carrier aggregation.

As shown by reference number 1005, the UE 120 may transmit, and the base station 110 may receive, a report 1005a (e.g., an enhanced MPE report), in a similar manner as described in connection with FIG. 8. The UE 120 may transmit the report 1005a in a PUSCH on a first component carrier CC1, as shown. The report 1005a may indicate respective candidate beams (e.g., one or more candidate beams) for one or more MPE component carriers. For example, as shown, the report may indicate a first beam beam 1 for the first component carrier CC1 and a second beam beam2 for a second component carrier CC2.

As shown by reference number 1010, the base station 110 may transmit, and the UE 120 may receive, a response DCI message 1010a scheduling an uplink communication. The DCI message 1010a may include a plurality of fields 1012, as described in connection with FIG. 9. Additionally, the DCI message 1010a may include a beam resetting indications field 1014 (e.g., that includes a bitmap of beam resetting indications). For example, the DCI message 1010a may include respective fields 1014a, 1014b (e.g., bits) for component carriers indicating whether beam resetting is to be performed, as described herein. For example, as shown, the DCI message 1010a may include a first indication in field 1014a of whether beam resetting is to be performed for the first component carrier CC1 (CC1=true) and a second indication in field 1014b of whether beam resetting is to be performed for the second component carrier CC2 (CC2=true). As described herein, the beam resetting indications of the beam resetting indications field 1014 of the DCI message 1010a may be mapped one-to-one with the MPE component carriers reported by the UE 120, as shown, or mapped one-to-one with all of the component carriers configured for carrier aggregation.

The UE 120 may reset the uplink beams only for component carriers of the MPE component carriers indicated for beam resetting in the DCI message 1010a. In the example 1000, the DCI message 1010a indicates that beam resetting is to be performed for both the first component carrier CC1 (CC1=true) and the second component carrier CC2 (CC2=true). Accordingly, the UE 120 may reset the uplink beam for the first component carrier CC1 to the first beam beam 1 and reset the uplink beam for the second component carrier CC2 to the second beam beam 2.

As shown by reference number 1015, the UE 120 may transmit, and the base station 110 may receive, the uplink communication on a component carrier using a candidate beam (e.g., using a same spatial domain filter as a spatial domain filter corresponding to the best candidate beam for the component carrier). For example, the UE 120 may transmit the uplink communication on the first component carrier CC1 using the first beam beam 1, and the UE 120 may transmit the uplink communication on the second component carrier CC2 using the second beam beam 2, as shown.

As indicated above, FIG. 10 is provided as an example. Other examples may differ from what is described with respect to FIG. 10.

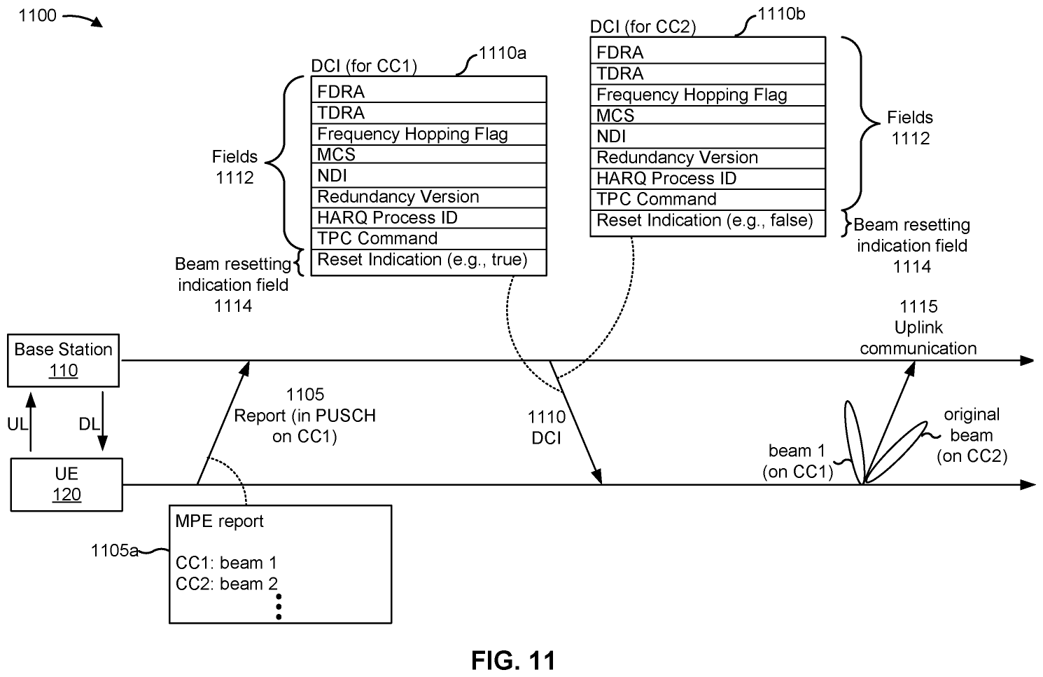

FIG. 11 is a diagram illustrating an example 1100 associated with beam indication for multiple component carriers following an MPE event, in accordance with the present disclosure. As shown in FIG. 11, a base station 110 and a UE 120 may communicate with one another. For example, the base station 110 and the UE 120 may communicate using carrier aggregation, as described herein. That is, the UE 120 may be configured with multiple component carriers for communication using carrier aggregation.

As shown by reference number 1105, the UE 120 may transmit, and the base station 110 may receive, a report 1105a (e.g., an enhanced MPE report), in a similar manner as described in connection with FIG. 8. The UE 120 may transmit the report 1105a in a PUSCH on a first component carrier CC1, as shown. The report 1105a may indicate respective candidate beams (e.g., one or more candidate beams) for one or more MPE component carriers. For example, as shown, the report 1105a may indicate a first beam beam 1 for the first component carrier CC1 and a second beam beam 2 for a second component carrier CC2.

As shown by reference number 1110, the base station 110 may transmit, and the UE 120 may receive, multiple response DCI messages 1110a, 1110b scheduling an uplink communication. For example, the base station 110 may transmit the multiple DCI messages 1110a, 1110b respectively on the MPE component carriers. Each of the DCI messages 1110a, 1110b may include a plurality of fields 1112, as described in connection with FIG. 9. The multiple DCI messages 1110a, 1110b may respectively indicate whether beam resetting is to be performed for the MPE component carriers. For example, as shown, a first DCI message 1110a for the first component carrier CC1 may include a beam resetting indication field 1114 indicating whether beam resetting is to be performed for the first component carrier CC1 (reset indication=true) and a second DCI message 1110b for the second component carrier CC2 may include a beam resetting indication field 1114 indicating whether beam resetting is to be performed for the second component carrier CC2 (reset indication=false).

The UE 120 may reset the uplink beams only for component carriers of the MPE component carriers indicated for beam resetting in the multiple DCI messages 1110a, 1110b. In the example 1100, the first DCI message 1110a indicates that beam resetting is to be performed for the first component carrier CC1 (reset indication=true), and the second DCI message 1110b indicates that beam resetting is not to be performed for the second component carrier CC2 (reset indication=false). Accordingly, the UE 120 may reset the uplink beam for the first component carrier CC1 to the first beam beam 1 and refrain from resetting the uplink beam for the second component carrier CC2 to the second beam beam 2.

As shown by reference number 1115, the UE 120 may transmit, and the base station 110 may receive, the uplink communication on a component carrier using a candidate beam (e.g., using a same spatial domain filter as a spatial domain filter corresponding to the best candidate beam for the component carrier). For example, the UE 120 may transmit the uplink communication on the first component carrier CC1 using the first beam beam 1. However, the UE 120 may transmit the uplink communication on the second component carrier CC2 using the original uplink beam for the second component carrier CC2 (i.e., not using the second beam beam 2), as shown.

As indicated above, FIG. 11 is provided as an example. Other examples may differ from what is described with respect to FIG. 11.

FIG. 12 is a diagram illustrating an example process 1200 performed, for example, by a UE, in accordance with the present disclosure. Example process 1200 is an example where the UE (e.g., UE 120) performs operations associated with beam indication for multiple component carriers following an MPE event.

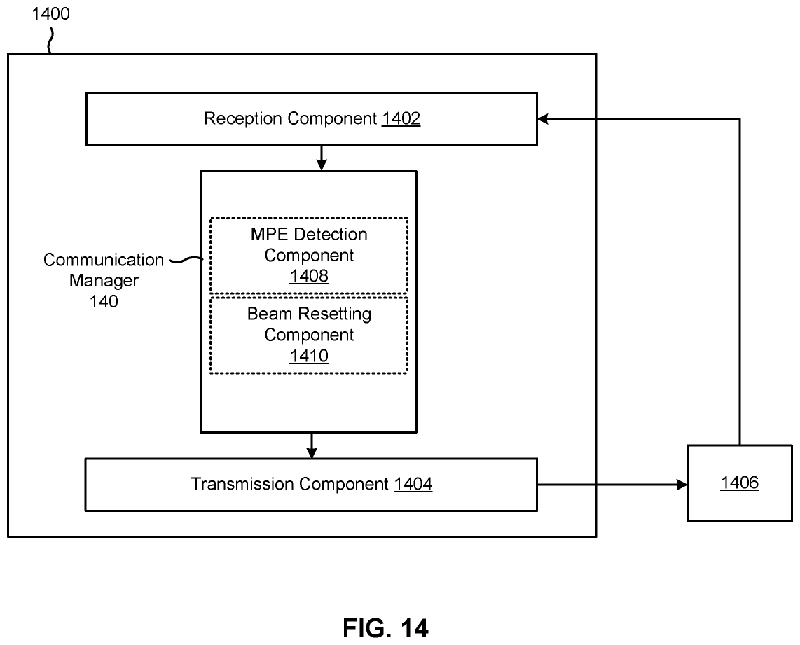

In some aspects, process 1200 may include receiving, from a base station, a configuration of multiple component carriers for use for carrier aggregation (block 1202). For example, the UE (e.g., using communication manager 140 and/or reception component 1402, depicted in FIG. 14) may receive, from the base station, a configuration of multiple component carriers for use for carrier aggregation, as described above.

In some aspects, process 1200 may include detecting an MPE event for one or more component carriers (block 1204). For example, the UE (e.g., using communication manager 140 and/or MPE detection component 1408, depicted in FIG. 14) detect an MPE event for one or more component carriers, as described above.

As shown in FIG. 12, in some aspects, process 1200 may include transmitting, to the base station, a report associated with an MPE event that has occurred for one or more component carriers, the report indicating one or more candidate beams for each of the one or more component carriers (block 1210). For example, the UE (e.g., using communication manager 140 and/or transmission component 1404, depicted in FIG. 14) may transmit, to a base station, a report associated with an MPE event that has occurred for one or more component carriers, the report indicating one or more candidate beams for each of the one or more component carriers, as described above.

As further shown in FIG. 12, in some aspects, process 1200 may include receiving, from the base station, at least one DCI message scheduling an uplink communication on the one or more component carriers (block 1220). For example, the UE (e.g., using communication manager 140 and/or reception component 1402, depicted in FIG. 14) may receive, from the base station, at least one DCI message scheduling an uplink communication on the one or more component carriers, as described above.

In some aspects, process 1200 may include resetting one or more uplink beams for the one or more component carriers (block 1222). For example, the UE (e.g., using communication manager 140 and/or beam resetting component 1410, depicted in FIG. 14) may reset one or more uplink beams for the one or more component carriers, as described above.

As further shown in FIG. 12, in some aspects, process 1200 may include transmitting, to the base station, the uplink communication on the one or more component carriers using at least one transmit beam that corresponds to a candidate beam of the one or more candidate beams for a component carrier of the one or more component carriers (block 1230). For example, the UE (e.g., using communication manager 140 and/or transmission component 1404, depicted in FIG. 14) may transmit, to the base station, the uplink communication on the one or more component carriers using at least one transmit beam that corresponds to a candidate beam of the one or more candidate beams for a component carrier of the one or more component carriers, as described above.

Process 1200 may include additional aspects, such as any single aspect or any combination of aspects described below and/or in connection with one or more other processes described elsewhere herein.

In a first aspect, transmitting the uplink communication includes transmitting the uplink communication using transmit beams that correspond to candidate beams for all of the one or more component carriers in response to the at least one DCI message being received.

In a second aspect, alone or in combination with the first aspect, the at least one DCI message is in a format for scheduling a PUSCH transmission, the at least one DCI message indicates a same HARQ process identifier as an HARQ process identifier for a transmission of a first PUSCH for the report, and the at least one DCI message indicates a toggled new data indicator.

In a third aspect, alone or in combination with one or more of the first and second aspects, transmitting the uplink communication includes transmitting the uplink communication after a threshold quantity of symbols from a last symbol of a physical downlink control channel carrying the at least one DCI message.

In a fourth aspect, alone or in combination with one or more of the first through third aspects, an SCS configuration for the threshold quantity of symbols is a first SCS configuration for an active downlink bandwidth part for the physical downlink control channel carrying the at least one DCI message, or a second SCS configuration for at least one secondary cell associated with the one or more component carriers.

In a fifth aspect, alone or in combination with one or more of the first through fourth aspects, transmitting the uplink communication includes transmitting the uplink communication using transmit beams that correspond to candidate beams for only component carriers of the one or more component carriers indicated for beam resetting in the at least one DCI message.

In a sixth aspect, alone or in combination with one or more of the first through fifth aspects, the at least one DCI message includes a single DCI message that includes respective fields for component carriers that provide beam resetting indications.

In a seventh aspect, alone or in combination with one or more of the first through sixth aspects, the respective fields are mapped one-to-one with the one or more component carriers.

In an eighth aspect, alone or in combination with one or more of the first through seventh aspects, the respective fields are mapped one-to-one with all component carriers configured for the UE.

In a ninth aspect, alone or in combination with one or more of the first through eighth aspects, the at least one DCI message includes multiple DCI messages that respectively provide beam resetting indications for the one or more component carriers.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, by a base station, in accordance with the present disclosure. Example process 1300 is an example where the base station (e.g., base station 110) performs operations associated with beam indication for multiple component carriers following an MPE event.

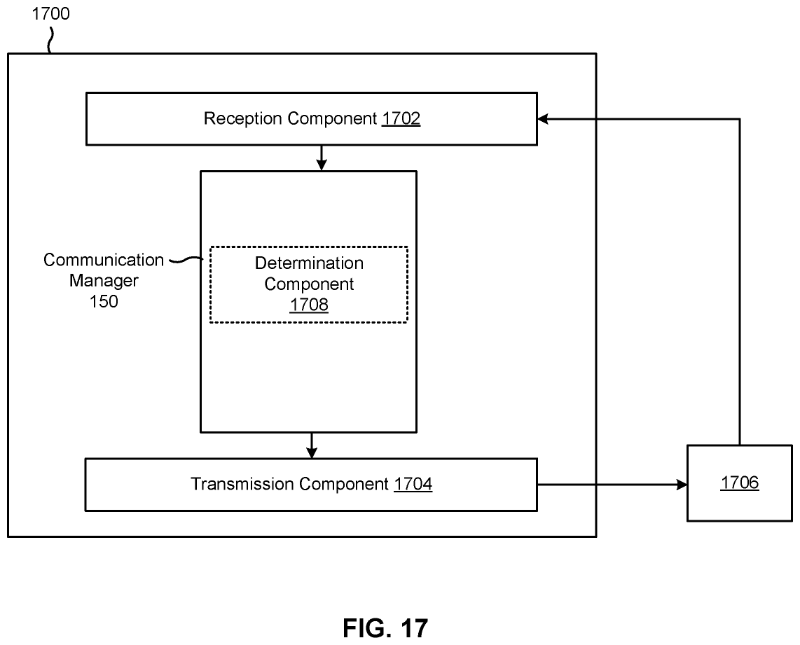

In some aspects, process 1300 may include transmitting, to a UE, a configuration of multiple component carriers for use for carrier aggregation (block 1302). For example, the base station (e.g., using communication manager 150 and/or transmission component 1704, depicted in FIG. 17) may transmit, to the UE, a configuration of multiple component carriers for use for carrier aggregation, as described above.

As shown in FIG. 13, in some aspects, process 1300 may include receiving, from the UE, a report associated with an MPE event that has occurred for one or more component carriers, the report indicating one or more candidate beams for each of the one or more component carriers (block 1310). For example, the base station (e.g., using communication manager 150 and/or reception component 1702, depicted in FIG. 17) may receive, from a UE, a report associated with an MPE event that has occurred for one or more component carriers, the report indicating one or more candidate beams for each of the one or more component carriers, as described above.

In some aspects, process 1300 may include determining whether the UE is to reset uplink beams for the one or more component carriers (block 1312). For example, the base station (e.g., using communication manager 150 and/or determination component 1708, depicted in FIG. 17) may determine whether the UE is to reset uplink beams for the one or more component carriers, as described above.

As further shown in FIG. 13, in some aspects, process 1300 may include transmitting, to the UE, at least one DCI message scheduling an uplink communication on the one or more component carriers (block 1320). For example, the base station (e.g., using communication manager 150 and/or transmission component 1704, depicted in FIG. 17) may transmit, to the UE, at least one DCI message scheduling an uplink communication on the one or more component carriers, as described above.

As further shown in FIG. 13, in some aspects, process 1300 may include receiving, from the UE, the uplink communication on the one or more component carriers using at least one receive beam that corresponds to a candidate beam of the one or more candidate beams for a component carrier of the one or more component carriers (block 1330). For example, the base station (e.g., using communication manager 150 and/or reception component 1702, depicted in FIG. 17) may receive, from the UE, the uplink communication on the one or more component carriers using at least one receive beam that corresponds to a candidate beam of the one or more candidate beams for a component carrier of the one or more component carriers, as described above.

Process 1300 may include additional aspects, such as any single aspect or any combination of aspects described below and/or in connection with one or more other processes described elsewhere herein.

In a first aspect, receiving the uplink communication includes receiving the uplink communication using receive beams that correspond to candidate beams for all of the one or more component carriers in response to the at least one DCI message being transmitted.

In a second aspect, alone or in combination with the first aspect, the at least one DCI message is in a format for scheduling a PUSCH transmission, the at least one DCI message indicates a same HARQ process identifier as an HARQ process identifier for a transmission of a first PUSCH for the report, and the at least one DCI message indicates a toggled new data indicator.

In a third aspect, alone or in combination with one or more of the first and second aspects, receiving the uplink communication includes receiving the uplink communication after a threshold quantity of symbols from a last symbol of a physical downlink control channel carrying the at least one DCI message.

In a fourth aspect, alone or in combination with one or more of the first through third aspects, an SCS configuration for the threshold quantity of symbols is a first SCS configuration for an active downlink bandwidth part for the physical downlink control channel carrying the at least one DCI message, or a second SCS configuration for at least one secondary cell associated with the one or more component carriers.

In a fifth aspect, alone or in combination with one or more of the first through fourth aspects, receiving the uplink communication includes receiving the uplink communication using receive beams that correspond to candidate beams for only component carriers of the one or more component carriers indicated for beam resetting in the at least one DCI message.

In a sixth aspect, alone or in combination with one or more of the first through fifth aspects, the at least one DCI message includes a single DCI message that includes respective fields for component carriers that provide beam resetting indications.

In a seventh aspect, alone or in combination with one or more of the first through sixth aspects, the respective fields are mapped one-to-one with the one or more component carriers.

In an eighth aspect, alone or in combination with one or more of the first through seventh aspects, the respective fields are mapped one-to-one with all component carriers configured for the UE.

In a ninth aspect, alone or in combination with one or more of the first through eighth aspects, the at least one DCI message includes multiple DCI messages that respectively provide beam resetting indications for the one or more component carriers.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram of an example apparatus 1400 for wireless communication. The apparatus 1400 may be a UE, or a UE may include the apparatus 1400. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE, a base station, or another wireless communication device) using the reception component 1402 and the transmission component 1404. As further shown, the apparatus 1400 may include the communication manager 140. The communication manager 140 may include one or more of a MPE detection component 1408 or a beam resetting component 1410, among other examples.

In some aspects, the apparatus 1400 may be configured to perform one or more operations described herein in connection with FIGS. 8-11. Additionally, or alternatively, the apparatus 1400 may be configured to perform one or more processes described herein, such as process 1200 of FIG. 12, or a combination thereof. In some aspects, the apparatus 1400 and/or one or more components shown in FIG. 14 may include one or more components of the UE described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the UE described in connection with FIG. 2.

The transmission component 1404 may transmit communications, such as reference signals, control information, data communications, or a combination thereof, to the apparatus 1406. In some aspects, one or more other components of the apparatus 1400 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modem, a modulator, a transmit MIMO processor, a transmit processor, a controller/processor, a memory, or a combination thereof, of the UE described in connection with FIG. 2. In some aspects, the transmission component 1404 may be co-located with the reception component 1402 in a transceiver.

The reception component 1402 may receive, from a base station, a configuration of multiple component carriers for use for carrier aggregation. The MPE detection component 1408 may detect an MPE event for one or more component carriers. The transmission component 1404 may transmit, to the base station, a report associated with an MPE event that has occurred for one or more component carriers, the report indicating one or more candidate beams for each of the one or more component carriers. The reception component 1402 may receive, from the base station, at least one DCI message scheduling an uplink communication on the one or more component carriers. The beam resetting component 1410 may reset one or more uplink beams for the one or more component carriers (e.g., in accordance with the DCI). The transmission component 1404 may transmit, to the base station, the uplink communication on the one or more component carriers using at least one transmit beam (e.g., uplink beam) that corresponds to a candidate beam of the one or more candidate beams for a component carrier of the one or more component carriers.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

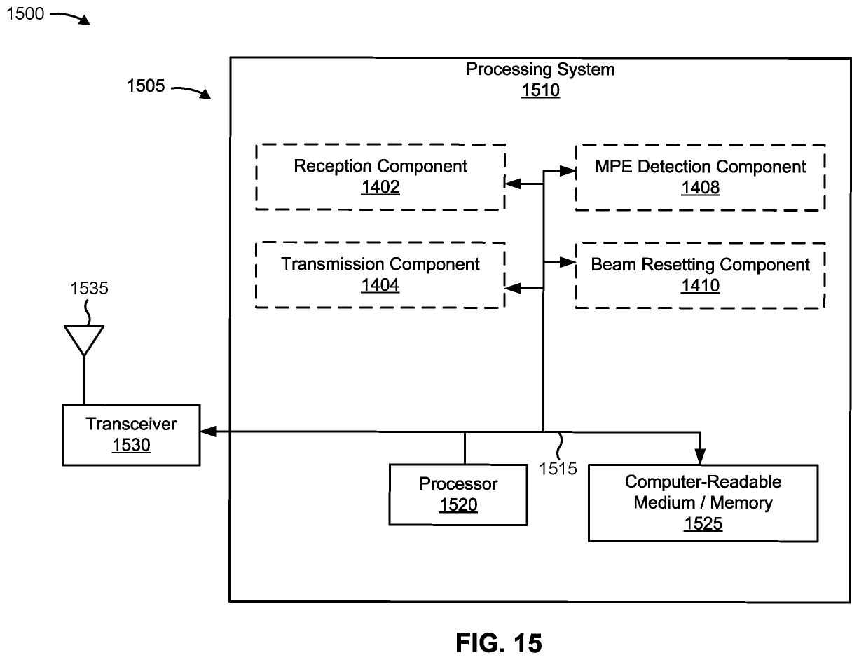

FIG. 15 is a diagram illustrating an example 1500 of a hardware implementation for an apparatus 1505 employing a processing system 1510. The apparatus 1505 may be a UE.

The processing system 1510 may be implemented with a bus architecture, represented generally by the bus 1515. The bus 1515 may include any number of interconnecting buses and bridges depending on the specific application of the processing system 1510 and the overall design constraints. The bus 1515 links together various circuits including one or more processors and/or hardware components, represented by the processor 1520, the illustrated components, and the computer-readable medium/memory 1525. The bus 1515 may also link various other circuits, such as timing sources, peripherals, voltage regulators, and/or power management circuits.

The processing system 1510 may be coupled to a transceiver 1530. The transceiver 1530 is coupled to one or more antennas 1535. The transceiver 1530 provides a means for communicating with various other apparatuses over a transmission medium. The transceiver 1530 receives a signal from the one or more antennas 1535, extracts information from the received signal, and provides the extracted information to the processing system 1510, specifically the reception component 1402. In addition, the transceiver 1530 receives information from the processing system 1510, specifically the transmission component 1404, and generates a signal to be applied to the one or more antennas 1535 based at least in part on the received information.

The processing system 1510 includes a processor 1520 coupled to a computer-readable medium/memory 1525. The processor 1520 is responsible for general processing, including the execution of software stored on the computer-readable medium/memory 1525. The software, when executed by the processor 1520, causes the processing system 1510 to perform the various functions described herein for any particular apparatus. The computer-readable medium/memory 1525 may also be used for storing data that is manipulated by the processor 1520 when executing software. The processing system further includes at least one of the illustrated components. The components may be software modules running in the processor 1520, resident/stored in the computer-readable medium/memory 1525, one or more hardware modules coupled to the processor 1520, or some combination thereof.

In some aspects, the processing system 1510 may be a component of the UE 120 and may include the memory 282 and/or at least one of the transmit MIMO processor 266, the receive processor 258, and/or the controller/processor 280. In some aspects, the apparatus 1505 for wireless communication includes means for transmitting, to a base station, a report associated with an MPE event that has occurred for one or more component carriers, the report indicating one or more candidate beams for each of the one or more component carrier, means for receiving, from the base station, at least one DCI message scheduling an uplink communication on the one or more component carriers, and/or means for transmitting, to the base station, the uplink communication on the one or more component carriers using at least one transmit beam that corresponds to a candidate beam of the one or more candidate beams for a component carrier of the one or more component carriers. The aforementioned means may be one or more of the aforementioned components of the apparatus 1400 and/or the processing system 1510 of the apparatus 1505 configured to perform the functions recited by the aforementioned means. As described elsewhere herein, the processing system 1510 may include the transmit MIMO processor 266, the receive processor 258, and/or the controller/processor 280. In one configuration, the aforementioned means may be the transmit MIMO processor 266, the receive processor 258, and/or the controller/processor 280 configured to perform the functions and/or operations recited herein.

FIG. 15 is provided as an example. Other examples may differ from what is described in connection with FIG. 15.

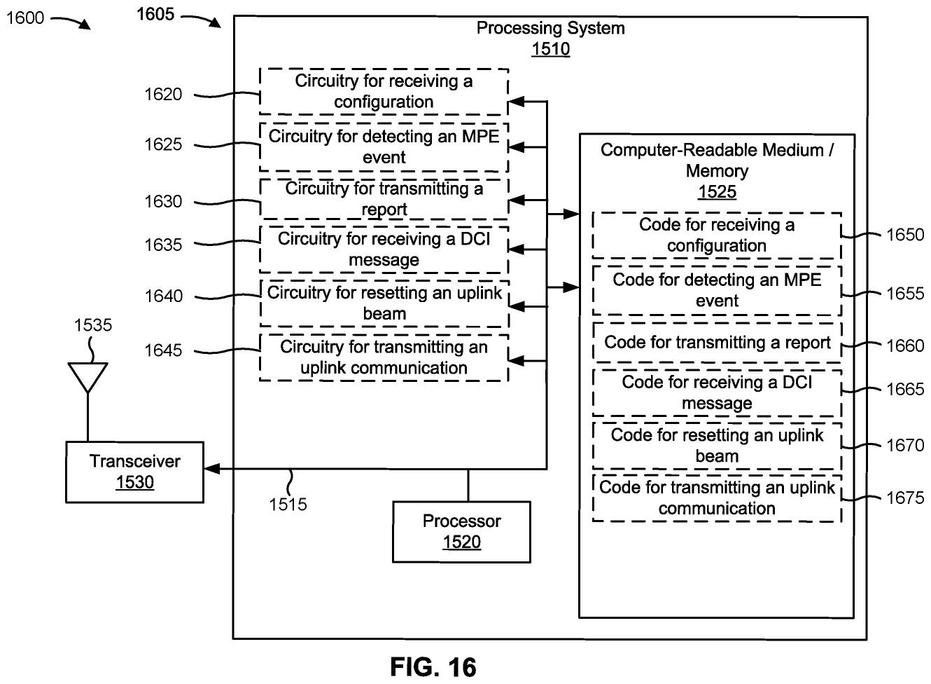

FIG. 16 is a diagram illustrating an example 1600 of an implementation of code and circuitry for an apparatus 1605, in accordance with the present disclosure. The apparatus 1605 may be a UE.

As shown in FIG. 16, the apparatus 1605 may include circuitry for receiving a configuration (circuitry 1620). For example, the circuitry 1620 may provide means for receiving a configuration of multiple component carriers for use for carrier aggregation.

As shown in FIG. 16, the apparatus 1605 may include circuitry for detecting an MPE event (circuitry 1625). For example, the circuitry 1625 may provide means for detecting an MPE event for one or more component carriers.

As shown in FIG. 16, the apparatus 1605 may include circuitry for transmitting a report (circuitry 1630). For example, the circuitry 1630 may provide means for transmitting a report associated with the MPE event that has occurred for the one or more component carriers.

As shown in FIG. 16, the apparatus 1605 may include circuitry for receiving a DCI message (circuitry 1635). For example, the circuitry 1635 may provide means for receiving at least one DCI message scheduling an uplink communication on the one or more component carriers.

As shown in FIG. 16, the apparatus 1605 may include circuitry for resetting an uplink beam (circuitry 1640). For example, the circuitry 1640 may provide means for resetting one or more uplink beams for the one or more component carriers.

As shown in FIG. 16, the apparatus 1605 may include circuitry for transmitting an uplink communication (circuitry 1645). For example, the circuitry 1645 may provide means for transmitting the uplink communication on the one or more component carriers using at least one transmit beam that corresponds to a candidate beam of the one or more candidate beams for a component carrier of the one or more component carriers.

The circuitry 1620, 1625, 1630, 1635, 1640, and/or 1645 may include one or more components of the UE described above in connection with FIG. 2, such as transmit processor 264, transmit MIMO processor 266, modem 254, MIMO detector 256, receive processor 258, antenna 252, controller/processor 280, and/or memory 282.

As shown in FIG. 16, the apparatus 1605 may include, stored in computer-readable medium 1525, code for receiving a configuration (code 1650). For example, the code 1650, when executed by the processor 1520, may cause the apparatus 1605 to receive a configuration of multiple component carriers for use for carrier aggregation.

As shown in FIG. 16, the apparatus 1605 may include, stored in computer-readable medium 1525, code for detecting an MPE event (code 1655). For example, the code 1655, when executed by the processor 1520, may cause the apparatus 1605 to detect an MPE event for one or more component carriers.

As shown in FIG. 16, the apparatus 1605 may include, stored in computer-readable medium 1525, code for transmitting a report (code 1660). For example, the code 1660, when executed by the processor 1520, may cause the apparatus 1605 to transmit a report associated with the MPE event that has occurred for the one or more component carriers.

As shown in FIG. 16, the apparatus 1605 may include, stored in computer-readable medium 1525, code for receiving a DCI message (code 1665). For example, the code 1665, when executed by the processor 1520, may cause the apparatus 1605 to receive at least one DCI message scheduling an uplink communication on the one or more component carriers.

As shown in FIG. 16, the apparatus 1605 may include, stored in computer-readable medium 1525, code for resetting an uplink beam (code 1670). For example, the code 1670, when executed by the processor 1520, may cause the apparatus 1605 to reset one or more uplink beams for the one or more component carriers.

As shown in FIG. 16, the apparatus 1605 may include, stored in computer-readable medium 1525, code for transmitting an uplink communication (code 1675). For example, the code 1675, when executed by the processor 1520, may cause the apparatus 1605 to transmit the uplink communication on the one or more component carriers using at least one transmit beam (e.g., uplink beam) that corresponds to a candidate beam of the one or more candidate beams for a component carrier of the one or more component carriers.

FIG. 16 is provided as an example. Other examples may differ from what is described in connection with FIG. 16.

FIG. 17 is a diagram of an example apparatus 1700 for wireless communication. The apparatus 1700 may be a base station, or a base station may include the apparatus 1700. In some aspects, the apparatus 1700 includes a reception component 1702 and a transmission component 1704, which may be in communication with one another (for example, via one or more buses and/or one or more other components). As shown, the apparatus 1700 may communicate with another apparatus 1706 (such as a UE, a base station, or another wireless communication device) using the reception component 1702 and the transmission component 1704. As further shown, the apparatus 1700 may include the communication manager 150. The communication manager 150 may include a determination component 1708, among other examples.

In some aspects, the apparatus 1700 may be configured to perform one or more operations described herein in connection with FIGS. 8-11. Additionally, or alternatively, the apparatus 1700 may be configured to perform one or more processes described herein, such as process 1300 of FIG. 13, or a combination thereof. In some aspects, the apparatus 1700 and/or one or more components shown in FIG. 17 may include one or more components of the base station described in connection with FIG. 2. Additionally, or alternatively, one or more components shown in FIG. 17 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1702 may receive communications, such as reference signals, control information, data communications, or a combination thereof, from the apparatus 1706. The reception component 1702 may provide received communications to one or more other components of the apparatus 1700. In some aspects, the reception component 1702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1700. In some aspects, the reception component 1702 may include one or more antennas, a modem, a demodulator, a MIMO detector, a receive processor, a controller/processor, a memory, or a combination thereof, of the base station described in connection with FIG. 2.

The transmission component 1704 may transmit communications, such as reference signals, control information, data communications, or a combination thereof, to the apparatus 1706. In some aspects, one or more other components of the apparatus 1700 may generate communications and may provide the generated communications to the transmission component 1704 for transmission to the apparatus 1706. In some aspects, the transmission component 1704 may perform signal processing on the generated communications (such as filtering, amplification, modulation, digital-to-analog conversion, multiplexing, interleaving, mapping, or encoding, among other examples), and may transmit the processed signals to the apparatus 1706. In some aspects, the transmission component 1704 may include one or more antennas, a modem, a modulator, a transmit MIMO processor, a transmit processor, a controller/processor, a memory, or a combination thereof, of the base station described in connection with FIG. 2. In some aspects, the transmission component 1704 may be co-located with the reception component 1702 in a transceiver.

The transmission component 1704 may transmit, to a UE, a configuration of multiple component carriers for use for carrier aggregation. The reception component 1702 may receive, from the UE, a report associated with an MPE event that has occurred for one or more component carriers, the report indicating one or more candidate beams for each of the one or more component carriers. The determination component 1708 may determine whether the UE is to reset uplink beams for the one or more component carriers. The transmission component 1704 may transmit, to the UE, at least one DCI message scheduling an uplink communication on the one or more component carriers (e.g., and indicating whether the UE is to reset uplink beams for the one or more component carriers). The reception component 1702 may receive, from the UE, the uplink communication on the one or more component carriers using at least one receive beam (e.g., uplink beam) that corresponds to a candidate beam of the one or more candidate beams for a component carrier of the one or more component carriers.

The number and arrangement of components shown in FIG. 17 are provided as an example. In practice, there may be additional components, fewer components, different components, or differently arranged components than those shown in FIG. 17. Furthermore, two or more components shown in FIG. 17 may be implemented within a single component, or a single component shown in FIG. 17 may be implemented as multiple, distributed components. Additionally, or alternatively, a set of (one or more) components shown in FIG. 17 may perform one or more functions described as being performed by another set of components shown in FIG. 17.

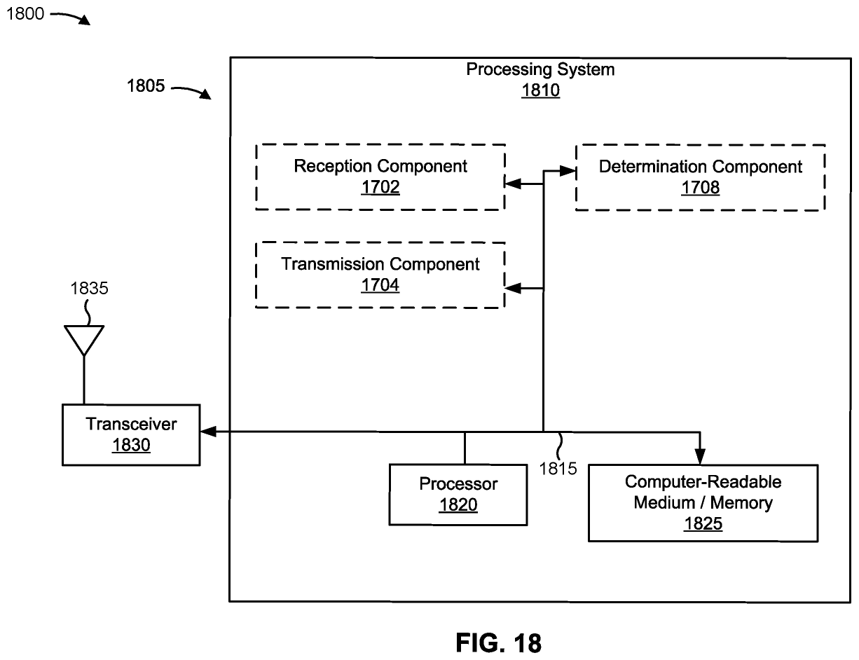

FIG. 18 is a diagram illustrating an example 1800 of a hardware implementation for an apparatus 1805 employing a processing system 1810. The apparatus 1805 may be a base station.

The processing system 1810 may be implemented with a bus architecture, represented generally by the bus 1815. The bus 1815 may include any number of interconnecting buses and bridges depending on the specific application of the processing system 1810 and the overall design constraints. The bus 1815 links together various circuits including one or more processors and/or hardware components, represented by the processor 1820, the illustrated components, and the computer-readable medium/memory 1825. The bus 1815 may also link various other circuits, such as timing sources, peripherals, voltage regulators, and/or power management circuits.

The processing system 1810 may be coupled to a transceiver 1830. The transceiver 1830 is coupled to one or more antennas 1835. The transceiver 1830 provides a means for communicating with various other apparatuses over a transmission medium. The transceiver 1830 receives a signal from the one or more antennas 1835, extracts information from the received signal, and provides the extracted information to the processing system 1810, specifically the reception component 1702. In addition, the transceiver 1830 receives information from the processing system 1810, specifically the transmission component 1704, and generates a signal to be applied to the one or more antennas 1835 based at least in part on the received information.

The processing system 1810 includes a processor 1820 coupled to a computer-readable medium/memory 1825. The processor 1820 is responsible for general processing, including the execution of software stored on the computer-readable medium/memory 1825. The software, when executed by the processor 1820, causes the processing system 1810 to perform the various functions described herein for any particular apparatus. The computer-readable medium/memory 1825 may also be used for storing data that is manipulated by the processor 1820 when executing software. The processing system further includes at least one of the illustrated components. The components may be software modules running in the processor 1820, resident/stored in the computer-readable medium/memory 1825, one or more hardware modules coupled to the processor 1820, or some combination thereof.

In some aspects, the processing system 1810 may be a component of the base station 110 and may include the memory 242 and/or at least one of the transmit MIMO processor 230, the receive processor 238, and/or the controller/processor 240. In some aspects, the apparatus 1805 for wireless communication includes means for receiving, from a UE, a report associated with an MPE event that has occurred for one or more component carriers, the report indicating one or more candidate beams for each of the one or more component carriers, means for transmitting, to the UE, at least one DCI message scheduling an uplink communication on the one or more component carriers, and/or means for receiving, from the UE, the uplink communication on the one or more component carriers using at least one receive beam that corresponds to a candidate beam of the one or more candidate beams for a component carrier of the one or more component carriers. The aforementioned means may be one or more of the aforementioned components of the apparatus 1700 and/or the processing system 1810 of the apparatus 1805 configured to perform the functions recited by the aforementioned means. As described elsewhere herein, the processing system 1810 may include the TX MIMO processor 230, the receive processor 238, and/or the controller/processor 240. In one configuration, the aforementioned means may be the TX MIMO processor 230, the receive processor 238, and/or the controller/processor 240 configured to perform the functions and/or operations recited herein.

FIG. 18 is provided as an example. Other examples may differ from what is described in connection with FIG. 18.

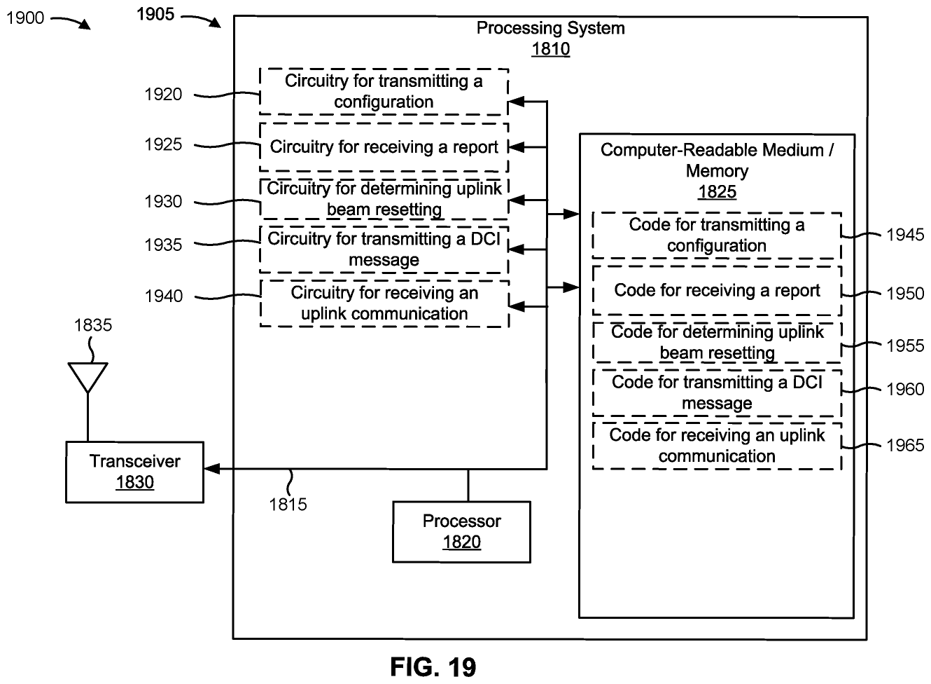

FIG. 19 is a diagram illustrating an example 1900 of an implementation of code and circuitry for an apparatus 1905, in accordance with the present disclosure. The apparatus 1905 may be a base station.

As shown in FIG. 19, the apparatus 1905 may include circuitry for transmitting a configuration (circuitry 1920). For example, the circuitry 1920 may provide means for transmitting a configuration of multiple component carriers for use for carrier aggregation.

As shown in FIG. 19, the apparatus 1905 may include circuitry for receiving a report (circuitry 1925). For example, the circuitry 1925 may provide means for receiving a report associated with an MPE event that has occurred for one or more component carriers.

As shown in FIG. 19, the apparatus 1905 may include circuitry for determining uplink beam resetting (circuitry 1930). For example, the circuitry 1930 may provide means for determining whether a UE is to reset uplink beams for the one or more component carriers.

As shown in FIG. 19, the apparatus 1905 may include circuitry for transmitting a DCI message (circuitry 1935). For example, the circuitry 1935 may provide means for transmitting at least one DCI message scheduling an uplink communication on the one or more component carriers.

As shown in FIG. 19, the apparatus 1905 may include circuitry for receiving an uplink communication (circuitry 1940). For example, the circuitry 1940 may provide means for receiving the uplink communication on the one or more component carriers using at least one receive beam that corresponds to a candidate beam of the one or more candidate beams for a component carrier of the one or more component carriers.

The circuitry 1920, 1925, 1930, 1935, and/or 1940 may include one or more components of the base station described above in connection with FIG. 2, such as transmit processor 220, transmit MIMO processor 230, modem 232, antenna 234, MIMO detector 236, receive processor 238, controller/processor 240, memory 242, and/scheduler 246.

As shown in FIG. 19, the apparatus 1905 may include, stored in computer-readable medium 1825, code for transmitting a configuration (code 1945). For example, the code 1945, when executed by the processor 1820, may cause the apparatus 1905 to transmit a configuration of multiple component carriers for use for carrier aggregation.

As shown in FIG. 19, the apparatus 1905 may include, stored in computer-readable medium 1825, code for receiving a report (code 1950). For example, the code 1950, when executed by the processor 1820, may cause the apparatus 1905 to receive a report associated with an MPE event that has occurred for one or more component carriers.

As shown in FIG. 19, the apparatus 1905 may include, stored in computer-readable medium 1825, code for determining uplink beam resetting (code 1955). For example, the code 1955, when executed by the processor 1820, may cause the apparatus 1905 to determine whether a UE is to reset uplink beams for the one or more component carriers.

As shown in FIG. 19, the apparatus 1905 may include, stored in computer-readable medium 1825, code for transmitting a DCI message (code 1960). For example, the code 1960, when executed by the processor 1820, may cause the apparatus 1905 to transmit at least one DCI message scheduling an uplink communication on the one or more component carriers.

As shown in FIG. 19, the apparatus 1905 may include, stored in computer-readable medium 1825, code for receiving an uplink communication (code 1965). For example, the code 1965, when executed by the processor 1820, may cause the apparatus 1905 to receive the uplink communication on the one or more component carriers using at least one receive beam that corresponds to a candidate beam of the one or more candidate beams for a component carrier of the one or more component carriers.

FIG. 19 is provided as an example. Other examples may differ from what is described in connection with FIG. 19.

The following provides an overview of some Aspects of the present disclosure:

Aspect 1: A method of wireless communication performed by a user equipment (UE), comprising: transmitting, to a base station, a report associated with a maximum permissible exposure (MPE) event that has occurred for one or more component carriers, the report indicating one or more candidate beams for each of the one or more component carriers; receiving, from the base station, at least one downlink control information (DCI) message scheduling an uplink communication on the one or more component carriers; and transmitting, to the base station, the uplink communication on the one or more component carriers using at least one transmit beam that corresponds to a candidate beam of the one or more candidate beams for a component carrier of the one or more component carriers.

Aspect 2: The method of Aspect 1, wherein transmitting the uplink communication comprises transmitting the uplink communication using transmit beams that correspond to candidate beams for all of the one or more component carriers in response to the at least one DCI message being received.

Aspect 3: The method of any of Aspects 1-2, wherein the at least one DCI message is in a format for scheduling a physical uplink shared channel (PUSCH) transmission, the at least one DCI message indicates a same hybrid automatic repeat request (HARQ) process identifier as an HARQ process identifier for a transmission of a first PUSCH for the report, and the at least one DCI message indicates a toggled new data indicator.

Aspect 4: The method of Aspect 3, wherein transmitting the uplink communication comprises transmitting the uplink communication after a threshold quantity of symbols from a last symbol of a physical downlink control channel carrying the at least one DCI message.

Aspect 5: The method of Aspect 4, wherein a subcarrier spacing (SCS) configuration for the threshold quantity of symbols is: a first SCS configuration for an active downlink bandwidth part for the physical downlink control channel carrying the at least one DCI message, or a second SCS configuration for at least one secondary cell associated with the one or more component carriers.

Aspect 6: The method of any of Aspects 1 and 3-5, wherein transmitting the uplink communication comprises transmitting the uplink communication using transmit beams that correspond to candidate beams for only component carriers of the one or more component carriers indicated for beam resetting in the at least one DCI message.

Aspect 7: The method of any of Aspects 1 and 3-6, wherein the at least one DCI message includes a single DCI message that includes respective fields for component carriers that provide beam resetting indications.

Aspect 8: The method of Aspect 7, wherein the respective fields are mapped one-to-one with the one or more component carriers.

Aspect 9: The method of Aspect 7, wherein the respective fields are mapped one-to-one with all component carriers configured for the UE.

Aspect 10: The method of any of Aspects 1 and 3-6, wherein the at least one DCI message includes multiple DCI messages that respectively provide beam resetting indications for the one or more component carriers.

Aspect 11: A method of wireless communication performed by a base station, comprising: receiving, from a user equipment (UE), a report associated with a maximum permissible exposure (MPE) event that has occurred for one or more component carriers, the report indicating one or more candidate beams for each of the one or more component carriers; transmitting, to the UE, at least one downlink control information (DCI) message scheduling an uplink communication on the one or more component carriers; and receiving, from the UE, the uplink communication on the one or more component carriers using at least one receive beam that corresponds to a candidate beam of the one or more candidate beams for a component carrier of the one or more component carriers.

Aspect 12: The method of Aspect 11, wherein receiving the uplink communication comprises receiving the uplink communication using receive beams that correspond to candidate beams for all of the one or more component carriers in response to the at least one DCI message being transmitted.

Aspect 13: The method of any of Aspects 11-12, wherein the at least one DCI message is in a format for scheduling a physical uplink shared channel (PUSCH) transmission, the at least one DCI message indicates a same hybrid automatic repeat request (HARQ) process identifier as an HARQ process identifier for a transmission of a first PUSCH for the report, and the at least one DCI message indicates a toggled new data indicator.

Aspect 14: The method of Aspect 13, wherein receiving the uplink communication comprises receiving the uplink communication after a threshold quantity of symbols from a last symbol of a physical downlink control channel carrying the at least one DCI message.

Aspect 15: The method of Aspect 14, wherein a subcarrier spacing (SCS) configuration for the threshold quantity of symbols is: a first SCS configuration for an active downlink bandwidth part for the physical downlink control channel carrying the at least one DCI message, or a second SCS configuration for at least one secondary cell associated with the one or more component carriers.

Aspect 16: The method of any of Aspects 11 and 13-15, wherein receiving the uplink communication comprises receiving the uplink communication using receive beams that correspond to candidate beams for only component carriers of the one or more component carriers indicated for beam resetting in the at least one DCI message.

Aspect 17: The method of any of Aspects 11 and 13-16, wherein the at least one DCI message includes a single DCI message that includes respective fields for component carriers that provide beam resetting indications.

Aspect 18: The method of Aspect 17, wherein the respective fields are mapped one-to-one with the one or more component carriers.

Aspect 19: The method of Aspect 17, wherein the respective fields are mapped one-to-one with all component carriers configured for the UE.

Aspect 20: The method of any of Aspects 11 and 13-16, wherein the at least one DCI message includes multiple DCI messages that respectively provide beam resetting indications for the one or more component carriers.

Aspect 21: An apparatus for wireless communication at a device, comprising a processor; memory coupled with the processor; and instructions stored in the memory and executable by the processor to cause the apparatus to perform the method of one or more of Aspects 1-10.

Aspect 22: A device for wireless communication, comprising a memory and one or more processors coupled to the memory, the one or more processors configured to perform the method of one or more of Aspects 1-10.

Aspect 23: An apparatus for wireless communication, comprising at least one means for performing the method of one or more of Aspects 1-10.

Aspect 24: A non-transitory computer-readable medium storing code for wireless communication, the code comprising instructions executable by a processor to perform the method of one or more of Aspects 1-10.

Aspect 25: A non-transitory computer-readable medium storing a set of instructions for wireless communication, the set of instructions comprising one or more instructions that, when executed by one or more processors of a device, cause the device to perform the method of one or more of Aspects 1-10.

Aspect 26: An apparatus for wireless communication at a device, comprising a processor; memory coupled with the processor; and instructions stored in the memory and executable by the processor to cause the apparatus to perform the method of one or more of Aspects 11-20.

Aspect 27: A device for wireless communication, comprising a memory and one or more processors coupled to the memory, the one or more processors configured to perform the method of one or more of Aspects 11-20.

Aspect 28: An apparatus for wireless communication, comprising at least one means for performing the method of one or more of Aspects 11-20.

Aspect 29: A non-transitory computer-readable medium storing code for wireless communication, the code comprising instructions executable by a processor to perform the method of one or more of Aspects 11-20.

Aspect 30: A non-transitory computer-readable medium storing a set of instructions for wireless communication, the set of instructions comprising one or more instructions that, when executed by one or more processors of a device, cause the device to perform the method of one or more of Aspects 11-20.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors coupled to the memory, the memory and the one or more processors configured to:
transmit, to a base station, a report associated with a maximum permissible exposure (MPE) event that has occurred for one or more component carriers, the report indicating one or more candidate beams for each of the one or more component carriers;
receive, from the base station, at least one downlink control information (DCI) message scheduling an uplink communication on the one or more component carriers; and
transmit, to the base station, the uplink communication on the one or more component carriers using at least one transmit beam that corresponds to a candidate beam of the one or more candidate beams for a component carrier of the one or more component carriers.

2. The apparatus of claim 1, wherein the memory and the one or more processors, to transmit the uplink communication, are configured to transmit the uplink communication using transmit beams that correspond to candidate beams for all of the one or more component carriers in response to the at least one DCI message being received.

3. The apparatus of claim 1, wherein the at least one DCI message is in a format for scheduling a physical uplink shared channel (PUSCH) transmission, the at least one DCI message indicates a same hybrid automatic repeat request (HARQ) process identifier as an HARQ process identifier for a transmission of a first PUSCH for the report, and the at least one DCI message indicates a toggled new data indicator.

4. The apparatus of claim 3, wherein the memory and the one or more processors, to transmit the uplink communication, are configured to transmit the uplink communication after a threshold quantity of symbols from a last symbol of a physical downlink control channel carrying the at least one DCI message.

5. The apparatus of claim 4, wherein a subcarrier spacing (SCS) configuration for the threshold quantity of symbols is:
a first SCS configuration for an active downlink bandwidth part for the physical downlink control channel carrying the at least one DCI message, or
a second SCS configuration for at least one secondary cell associated with the one or more component carriers.

6. The apparatus of claim 1, wherein the memory and the one or more processors, to transmit the uplink communication, are configured to transmit the uplink communication using transmit beams that correspond to candidate beams for only component carriers of the one or more component carriers indicated for beam resetting in the at least one DCI message.

7. The apparatus of claim 1, wherein the at least one DCI message includes a single DCI message that includes respective fields for component carriers that provide beam resetting indications.

8. The apparatus of claim 7, wherein the respective fields are mapped one-to-one with the one or more component carriers.

9. The apparatus of claim 7, wherein the respective fields are mapped one-to-one with all component carriers configured for the UE.

10. The apparatus of claim 1, wherein the at least one DCI message includes multiple DCI messages that respectively provide beam resetting indications for the one or more component carriers.

11. An apparatus for wireless communication at a base station, comprising:
a memory; and
one or more processors coupled to the memory, the memory and the one or more processors configured to:
receive, from a user equipment (UE), a report associated with a maximum permissible exposure (MPE) event that has occurred for one or more component carriers, the report indicating one or more candidate beams for each of the one or more component carriers;
transmit, to the UE, at least one downlink control information (DCI) message scheduling an uplink communication on the one or more component carriers; and
receive, from the UE, the uplink communication on the one or more component carriers using at least one receive beam that corresponds to a candidate beam of the one or more candidate beams for a component carrier of the one or more component carriers.

12. The apparatus of claim 11, wherein the memory and the one or more processors, to receive the uplink communication, are configured to receive the uplink communication using receive beams that correspond to candidate beams for all of the one or more component carriers in response to the at least one DCI message being transmitted.

13. The apparatus of claim 11, wherein the at least one DCI message is in a format for scheduling a physical uplink shared channel (PUSCH) transmission, the at least one DCI message indicates a same hybrid automatic repeat request (HARQ) process identifier as an HARQ process identifier for a transmission of a first PUSCH for the report, and the at least one DCI message indicates a toggled new data indicator.

14. The apparatus of claim 13, wherein the memory and the one or more processors, to receive the uplink communication, are configured to receive the uplink communication after a threshold quantity of symbols from a last symbol of a physical downlink control channel carrying the at least one DCI message.

15. The apparatus of claim 14, wherein a subcarrier spacing (SCS) configuration for the threshold quantity of symbols is:
a first SCS configuration for an active downlink bandwidth part for the physical downlink control channel carrying the at least one DCI message, or
a second SCS configuration for at least one secondary cell associated with the one or more component carriers.

16. The apparatus of claim 11, wherein the memory and the one or more processors, to receive the uplink communication, are configured to receive the uplink communication using receive beams that correspond to candidate beams for only component carriers of the one or more component carriers indicated for beam resetting in the at least one DCI message.

17. The apparatus of claim 11, wherein the at least one DCI message includes a single DCI message that includes respective fields for component carriers that provide beam resetting indications.

18. The apparatus of claim 17, wherein the respective fields are mapped one-to-one with the one or more component carriers.

19. The apparatus of claim 17, wherein the respective fields are mapped one-to-one with all component carriers configured for the UE.

20. The apparatus of claim 11, wherein the at least one DCI message includes multiple DCI messages that respectively provide beam resetting indications for the one or more component carriers.

21. A method of wireless communication performed by a user equipment (UE), comprising:
transmitting, to a base station, a report associated with a maximum permissible exposure (MPE) event that has occurred for one or more component carriers, the report indicating one or more candidate beams for each of the one or more component carriers;
receiving, from the base station, at least one downlink control information (DCI) message scheduling an uplink communication on the one or more component carriers; and
transmitting, to the base station, the uplink communication on the one or more component carriers using at least one transmit beam that corresponds to a candidate beam of the one or more candidate beams for a component carrier of the one or more component carriers.

22. The method of claim 21, wherein transmitting the uplink communication comprises transmitting the uplink communication using transmit beams that correspond to candidate beams for all of the one or more component carriers in response to the at least one DCI message being received.

23. The method of claim 21, wherein transmitting the uplink communication comprises transmitting the uplink communication using transmit beams that correspond to candidate beams for only component carriers of the one or more component carriers indicated for beam resetting in the at least one DCI message.

24. The method of claim 21, wherein the at least one DCI message includes a single DCI message that includes respective fields for component carriers that provide beam resetting indications.

25. The method of claim 21, wherein the at least one DCI message includes multiple DCI messages that respectively provide beam resetting indications for the one or more component carriers.

26. A method of wireless communication performed by a base station, comprising:
receiving, from a user equipment (UE), a report associated with a maximum permissible exposure (MPE) event that has occurred for one or more component carriers, the report indicating one or more candidate beams for each of the one or more component carriers;
transmitting, to the UE, at least one downlink control information (DCI) message scheduling an uplink communication on the one or more component carriers; and
receiving, from the UE, the uplink communication on the one or more component carriers using at least one receive beam that corresponds to a candidate beam of the one or more candidate beams for a component carrier of the one or more component carriers.

27. The method of claim 26, wherein receiving the uplink communication comprises receiving the uplink communication using receive beams that correspond to candidate beams for all of the one or more component carriers in response to the at least one DCI message being transmitted.

28. The method of claim 26, wherein receiving the uplink communication comprises receiving the uplink communication using receive beams that correspond to candidate beams for only component carriers of the one or more component carriers indicated for beam resetting in the at least one DCI message.

29. The method of claim 26, wherein the at least one DCI message includes a single DCI message that includes respective fields for component carriers that provide beam resetting indications.

30. The method of claim 26, wherein the at least one DCI message includes multiple DCI messages that respectively provide beam resetting indications for the one or more component carriers.
